(19) United States
(12) Patent Application Publication
(10) Pub. No.: US 2026/0019367 A1
(43) Pub. Date: Jan. 15, 2026

(54) METHODS AND APPARATUS FOR LOAD BALANCED LINK AGGREGATION

(71) Applicant: Intel Corporation, Santa Clara, CA (US)

(72) Inventors: Bhushan Girishkumar Parikh, Queen Creek, AZ (US); Surekha Peri, Austin, TX (US); Stephen Thomas Palermo, Chandler, AZ (US); Chad Langston Coburn, Round Rock, TX (US); Supraja Conjeti, Leander, TX (US); Vishal Goyal, Austin, TX (US)

(73) Assignee: Intel Corporation, Santa Clara, CA (US)

(21) Appl. No.: 19/329,303

(22) Filed: Sep. 15, 2025

(51) Int. Cl. H04L 47/125; H04L 47/34; H04L 47/41

(52) U.S. Cl. CPC H04L 47/125; H04L 47/34; H04L 47/41

(57) ABSTRACT

Systems, apparatus, articles of manufacture, and methods are disclosed. An example apparatus to perform network switching comprises: interface circuitry, machine-readable instructions, and at least one programmable circuit to at least one of instantiate or execute the machine-readable instructions to: assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG, and cause transmission of the plurality of packets across the first output port and the second output port in an order that maintains a relative position of the plurality of packets from the flow.

### BACKGROUND

In recent years, the number of User Equipment (UE) capable of requesting data over a network (such as the Internet) and their bandwidth capabilities have increased. In turn, the number of server devices designed to forward or respond to a request from a UE device have also increased. Techniques used to support the growing bandwidth requirements and growing number of source and destination devices while maintaining network performance include load balancing (LB) on a link aggregation group (LAG).

### BRIEF DESCRIPTION OF THE DRAWINGS

FIG. 1 is a block diagram in which an example network switch circuitry operates to perform load balancing (LB) on a link aggregation group (LAG).

FIG. 2 is a block diagram of an example implementation of the network switch circuitry of FIG. 1.

FIG. 3 is a block diagram of a first example environment that implements the network switch circuitry of FIG. 2.

FIG. 4 is a block diagram of a second example environment that implements the network switch circuitry of FIG. 2.

FIG. 5 is a block diagram of a third example environment that implements the network switch circuitry of FIG. 2.

FIG. 6 is a block diagram of a fourth example environment that implements the network switch circuitry of FIG. 2.

FIG. 7 is a block diagram of a fifth example environment that implements the network switch circuitry of FIG. 2.

FIG. 8 is an illustrative example of two transmission paths that include the network switch circuitry of FIG. 2.

FIG. 9 is a flowchart representative of example machine-readable instructions and/or example operations that may be executed, instantiated, and/or performed by programmable circuitry to implement the network switch circuitry of FIG. 2.

FIG. 10 is a flowchart representative of example machine-readable instructions and/or example operations that may be executed, instantiated, and/or performed by the network switch circuitry of FIG. 2 to predict the bandwidth of a packet as described in FIG. 9.

FIG. 11 is a flowchart representative of example machine-readable instructions and/or example operations that may be executed, instantiated, and/or performed by the network switch circuitry of FIG. 2 to train one or more artificial intelligence (AI) models to perform LB LAG.

FIG. 12 is a block diagram of an example processing platform including programmable circuitry structured to execute, instantiate, and/or perform the example machine-readable instructions and/or perform the example operations of FIGS. 9-11 to implement the network switch circuitry 102 of FIG. 2.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine-readable instructions of FIGS. 9-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Load Balancing (LB) in the network context generally refers to techniques to distribute network traffic in multiple directions with the goal of ensuring that none of the compute resources that support network traffic in any given direction become overutilized. LB can be performed on a variety of different scales. For example, suppose a plurality of requests from a plurality of UE devices all correspond to the same pre-defined task (e.g., send an email, browse social media, etc.) such that a given task can be handled by one of a plurality of destination devices. One or more intermediate network devices may perform LB operations to distribute the plurality of requests amongst the plurality of destination devices so that some destination devices or destination links do not become overwhelmed by their assigned tasks while other destination devices idle.

LB operations can also be performed within a single intermediate device (e.g. network switch circuitry), even if a destination device has already been determined. For example, suppose the network switch circuitry has x independent interface connections that can each support a maximum bandwidth y gigabytes per second (Gbps). In such an example, the network switch circuitry can support a data stream of up to (xy) Gbps provided the data is evenly distributed across the interface connections using LB. In some examples, the foregoing combination of multiple physical interface connections into a single logical connection is referred to as a link aggregation group (LAG). In some examples, the term “interface connections” may be used interchangeably with terms such as “ports” “terminals” and/or “pins”.

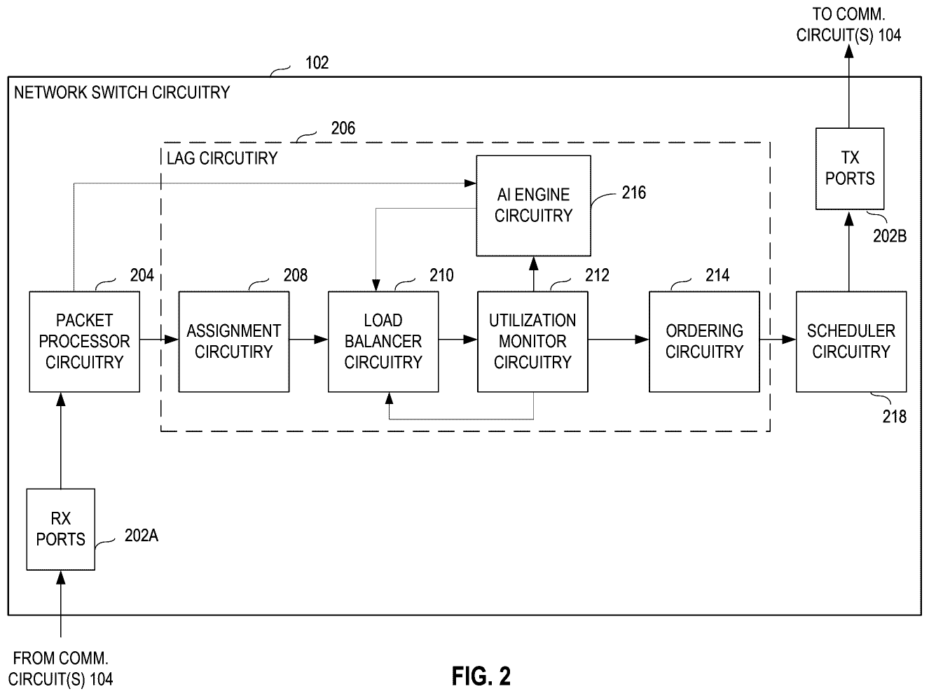

Known approaches to perform LB and LAG operations on the same networking device do so by keeping order-specific data together as a collective unit. As used herein, a “flow” refers to the smallest amount of data that requires in-order delivery to the receiver during operational (e.g., non failure) conditions of a network. Thus, a networking device that has multiple input sources (e.g., ports or local applications) and multiple output ports implements known LB and LAG approaches by forwarding the entire flow through a single output port. If the flow is divisible into smaller units (e.g., a packet), known networking devices forward the smaller units through the single output port in the same order that they were received from the single input port. Flows are described further in connection with FIG. 2.

Known networking devices pseudo-randomly determine which output port to forward a given flow through. For instance, many known networking devices execute a hash function using specific fields in a flow as inputs. The known networking device then assigns the flow to a particular output port based on the output of the hash function. While such approaches attempt to distribute flows amongst a plurality of output ports evenly, the pseudo-random nature of hash functions can result in situations where several consecutive flows are mapped to the same output port. Even if the known networking device does successfully assign an equal number of flows to each output port for a period, the output ports are still not guaranteed to exhibit equal bandwidth utilization over said period because flows are not guaranteed to contain the same amount of data. Accordingly, known approaches to perform LB and LAG operations in the same device can suffer from poor network performance due to their reliance on hash functions and clustering of order-specific data.

Example methods, apparatus, and systems described herein perform LB and LAG operations in the same device by breaking a given flow into multiple packets and forwarding the individual packets through different output ports. In some examples, load balancer circuitry determines which output port to forward a given packet through based on the bandwidth utilization of each output port as measured by example monitor circuitry. In other examples, AI engine circuitry determines which output port to forward a given packet through based on network parameters and telemetry data. Example ordering circuitry increases an order index whenever a packet is reassigned from a first output port to a second output port for LB purposes. The example ordering circuitry also sends packets through the output ports in an order determined by their ordering index. As a result, when receiving a flow that includes a plurality of packets, example network switch circuitry described herein ensures the packets are transmitted based on their relative position at an input port (e.g., based on the order in which they were received) even if different output ports are used to transmit various portions of the flow. Furthermore, the division and distribution of a single flow amongst multiple ports described in examples herein enables better network performance than known approaches while still providing the in-order delivery that a flow requires.

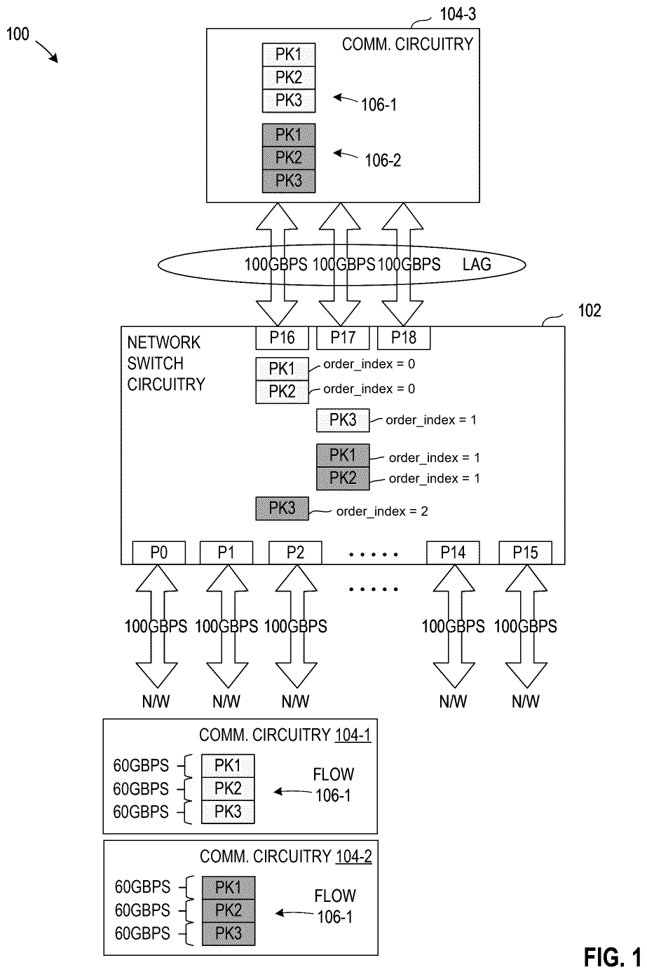

FIG. 1 is a block diagram of an example network 100. The network 100 includes example network switch circuitry 102, example communication circuitry 104-1, 104-2, 104-3, and example flows 106-1 and 106-2.

The network switch circuitry 102 performs LB and LAG operations in accordance with the teachings of this disclosure. In the example of FIG. 1, the network switch circuitry 102 includes eighteen labeled P1, P2, . . . P18. More generally, the network switch circuitry 102 may have any number of ports. The ports of FIG. 1 are bidirectional and thus a given port may be considered either an input or an output depending on its configuration. In the example configuration of FIGS. 1, P1-P15 operate as input ports while P16-P18 operate as output ports. In the example of FIG. 1, each port has a maximum bandwidth of 100 Gbps. However, by performing LAG operations in the example configuration of FIG. 1, the network switch circuitry 102 supports a 300 Gbps output data stream by combining P16, P17, and P18 into a single logical connection.

The network switch circuitry 102 may be implemented by any type of programmable circuitry. In some examples, the network switch circuitry 102 incudes a System on a Chip (SoC) that is included in a switch chassis. Examples of switch SoCs include but are not limited to the Broadcom® BCM5340, BCM5341, and BCM5345 series. Examples of a switch chassis include are but not limited to the Cisco® Catalyst 9600 series. The network switch circuitry 102 is described further in connection with FIG. 2.

The communication circuits 104 are computer resources (e.g., collections of hardware, software, and/or firmware) capable of exchanging data with one another over the network 100. In the example of FIG. 1, the communication circuitry 104-1 transmits the flow 106-1 to the communication circuitry 104-3 and the communication circuitry 104-2 transmits the flow 106-2 to the communication circuitry 104-3. The network switch circuitry 102 facilitates the exchange of both flows 106. In the example of FIG. 1, the network switch circuitry 102 receives the flow 106-1 through Pl first and then receives the flow 106-2 through the same P1. Accordingly, in FIG. 1, the flow 106-1 egresses from the network switch circuitry 102 before the flow 106-2.

In other examples, the network switch circuitry 102 may receive both flows 106 at the same time across two different input ports (e.g., PO and P1). More generally, a given communication circuit 104 may generate or receive any number of flows within a period. Flows generated by a given communication circuit 104 may correspond to the same or to different data streams (e.g., a request for data, a response, etc.). In some examples, the communication circuits 104 are each implemented on different devices. In other examples, one or more of the communication circuits 104 are implemented on the same device.

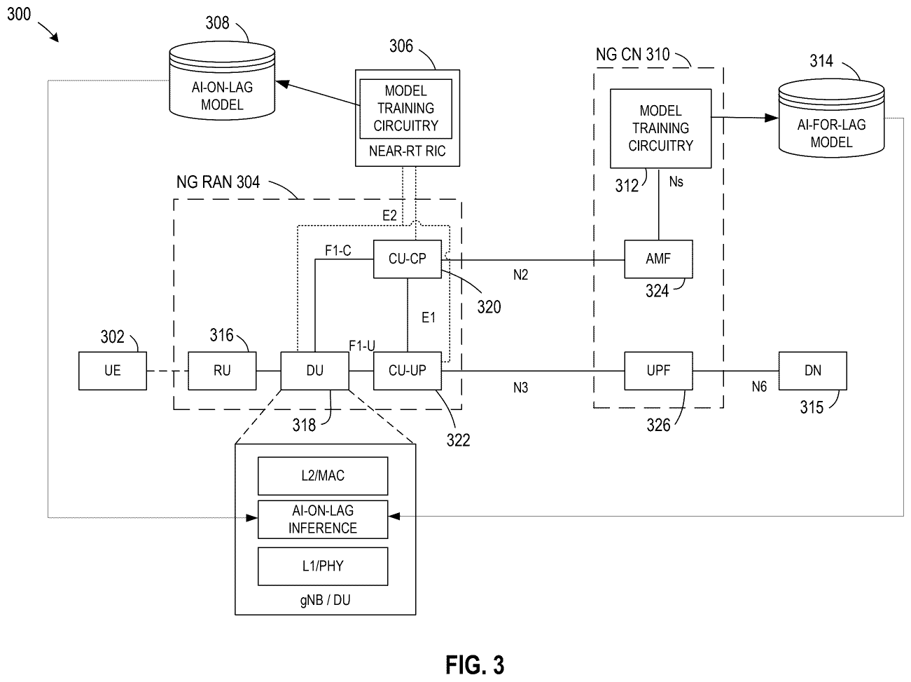

The communication circuitry 104 may include any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). Example implementations of the communication circuitry 104 are described further in connection with FIGS. 3-8.

The flows 106 are collections of packets where in-order delivery is necessary to avoid failure conditions within the network 100. In the example of FIG. 1, both flows 106 are composed of three packets labelled PK1, PK2, and PK3. The communication circuitry 104-3 may therefore exhibit a failure condition (e.g., raise an error, behave unexpectedly, etc.) unless, for both flows 106-1 and 106-2, the first packet arrives before the second packet, and the second packet arrives before the third packet.

A flow may be classified using any visible unencrypted packet header fields. For example, flow classifications can be based on parameters including but not limited Layer 2 and Layer 3 Open Systems Interconnection (OSI) fields such as a combination of: source or destination MAC addresses, Virtual Local Area Network (VLAN) identification values, source or destination Internet Protocol (IP) addresses, EtherType, protocol type, Multiprotocol Label Switching (MPLS) or segment routing tags, Secure Parameter Index (SPI) values, etc. Flows are not required to be equal in size. In other examples, one or more of the flows 106 are composed of a different number of packets per second.

Each individual packet in the flows 106 consume 60 Gbps of bandwidth in the example of FIG. 1. In this example, the network switch circuitry 102 performs initial assignments based on a hash function that results in all six packets from both flows 106 being assigned to P16. If the initial assignments were implemented, P16 would become overutilized while the other output ports become underutilized and idle. Bandwidth overutilization can cause a failure condition to occur (e.g., the port may queue and/or inadvertently drop packets), thereby degrading the performance of the network switch circuitry 102. Such suboptimal packet assignments can occur at any time with known approaches because such approaches make flow-level assignments based on hash functions. In some examples, the terms “overutilized” and “oversubscribed” may be used interchangeably.

Advantageously, the example network switch circuitry 102 mitigates the foregoing performance issues by performing packet-level assignments based on bandwidth utilization. For example, the network switch circuitry 102 identifies P16 is overutilized after PK1 and PK2 from the flow 106-1 are assigned to P16. This overutilization occurs because the bandwidth collectively consumed by PK1 and PK2 (120 Gbps) is greater than the bandwidth that P16 supports (100 Gbps). Although the network switch circuitry 102 must transmit PK1 before PK2 (as they are part of the same flow 106-1 and therefore order-specific), assigning PK1 and PK2 to the same port can still cause overutilization because the computational resources specific to P16 (e.g., memory resources such as a cache or a buffer, data transfer resources such as interconnect material and width, etc.) must simultaneously support both PK1 and PK2 in the intermediate period when both packets have been assigned but neither packet has been transmitted. Such periods of port overutilization can occur on a regular basis because the network switch circuitry 102 generally determines a final assignment for all packets in a flow before transmitting any of the packets across any of its output ports.

To prevent P16 from becoming further overutilized, the network switch circuitry 102 begins to re-assign packets that were initially assigned to P16 to a different port that is not overutilized (e.g., P17). In the example of FIG. 17, the network switch circuitry 102 assigns PK3 of flow 106-1, PK2 of 106-2, and PK3 of 106-2 to P17 before determining that P17 has become overutilized. Here, the amount of time between when the network switch circuitry 102 a) started to receive flow 106-1 and b) started to receive flow 106-2 allows for PK3 be transmitted across P17 before the assignment of PK2 of flow 106-2. Accordingly, the network switch circuitry 102 can reassign three consecutive packets to P17 while only incurring the same amount (e.g., minimal) of bandwidth overutilization as P16 previously exhibited.

After determining P17 has become overutilized, the network switch circuitry 102 re-assigns the last packet (PK3 of flow 106-2) to a different port that is not overutilized. In this example, the network switch circuitry 102 can re-assign PK3 of flow 106-2 back to P16 because PK1 and PK2 of flow 106-1 have already been transmitted, so P16 is no longer overutilized. Moreover, reducing the number of additional ports used to distribute packets from the same flow can be beneficial because redistributing packets from a first port to a second port may negatively impact the latency of packets already assigned to the second port. Thus, the network switch circuitry 102 re-assigns PK3 of flow 106-2 back to P16 so as to not disturb any data flows that may be occurring across P18 independently of the operations shown in FIG. 1.

A packet reassignment from a first output port to a second output port as shown in FIG. 1 raises the potential for a flow, now split amongst two or more physical connections, to arrive out of order at the next device and therefore raise a failure mode. Advantageously, the example network switch circuitry 102 transmits packets through a given ports in a sequence based on their order_index. Moreover, the network switch circuitry 102 updates the order_index of all subsequent packets whose final assignment is still pending whenever a packet is reassigned. As a result, the output ports collectively transmit the packets within a given flow in the same order in which they were received. For example, in FIG. 1, all six packets from the flows 106 are originally assigned order_index=0. After leaving PK1 and PK2 of flow 106-1 at assigned to P16, the network switch circuitry 102 increments the order_index values of all other packets shown in FIG. 1 to indicate the transition to P17. Thus, although an intermediate period may exist where all of PK1, PK2, and PK3 from flow 106-1 are ready for transmission, and the current state of the P17 computational resources (e.g., buffer capacity) can support the transmission of PK3 before P16 can transmit PK1 or PK2, the network switch circuitry 102 is guaranteed to wait to transmit PK3 until after both PK1 and PK2 because the order_index of PK3 (1) is greater than the order_index of both PK1 and PK2 (0).

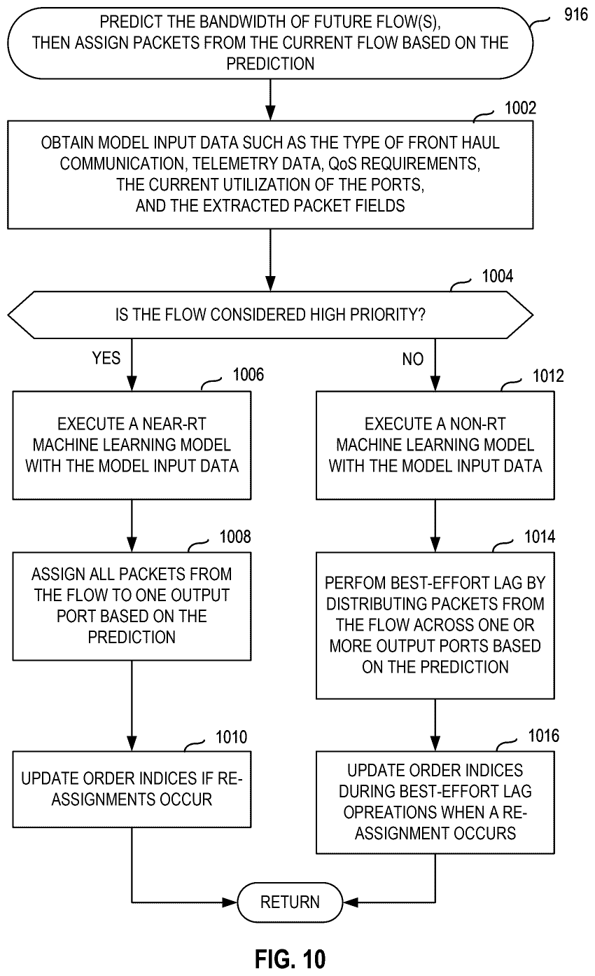

Similarly, the network switch circuitry 102 increments the order_index of PK3 of flow 106-2 again (making its value 2) to signify a transition from P17 back to P16. Here, the order_index ensures that P17 transmits PK1 and PK2 of flow 106-2 before P16 transmits PK3 of flow 106-2. The order_index is described further in connection with FIGS. 2, 10.

FIG. 2 is a block diagram of an example implementation of the network switch circuitry 102 of FIG. 1 to perform LAG and LB operations in accordance with the teachings of this disclosure. The network switch circuitry 102 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the network switch circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

FIG. 2 shows the network switch circuitry 102 includes example receive (RX) ports 202A and example transmit (TX) ports 202B (collectively referred to as ports 202), example packet processor circuitry 204, example LAG circuitry 206, and example scheduler circuitry 218. The LAG circuitry 206 includes example assignment circuitry 208, example load balancer circuitry 210, example utilization monitor circuitry 212, example ordering circuitry 214, and example Artificial intelligence (AI) engine circuitry 216.

The RX ports 202A are interface circuits that receive packets from one or more of the communication circuits 104 during a particular configuration of the network switch circuitry 102. Similarly, the TX ports 202B are interface circuits that forward packets to one or more of the communication circuits 104 during a particular configuration of the network switch circuitry 102. In some examples, one or more of the ports 202 are bi-directional interface circuits that can either send or receive data depending on the configuration of the network switch circuitry 102. Thus, the RX ports 202A refer to P1-P15 and the TX ports 202B refer to P16-18 in the example configuration of FIG. 1 but refer to different ones of P1-P20 in other configurations.

Each of the ports 202 can support data streams up to a predetermined bandwidth utilization threshold. If a given output port satisfies the predetermined threshold, the port is overutilized. As used herein, a port satisfies a utilization threshold if the bandwidth of the port is greater than the predetermined utilization threshold value. In other examples, a utilization may be satisfied if the bandwidth of a port is equal to the predetermined value, less than the predetermined value, etc.

An overutilized port (e.g., 202) can be forced to delay the receiving or transmission of one or more packets. Such delays may violate one or more Quality of Service (QOS) requirements set by the communication circuits 104 and/or the network 100. In some examples, the predetermined bandwidth utilization threshold of a given port 202 is referred to as its programmed bandwidth utilization. In the example of FIG. 1, the programmed bandwidth utilization for each of P1-P20 is 100 Gbps. In other examples, the programmed bandwidth utilization of one or more of the ports 202 are different from one another.

The network switch circuitry 102 may include transceivers, antennas, and/or other hardware components required to send and/or receive data through the ports 202. The network switch circuitry 102 may include any number of ports 202. A given port 202 may support wired and/or wireless communications as described further below.

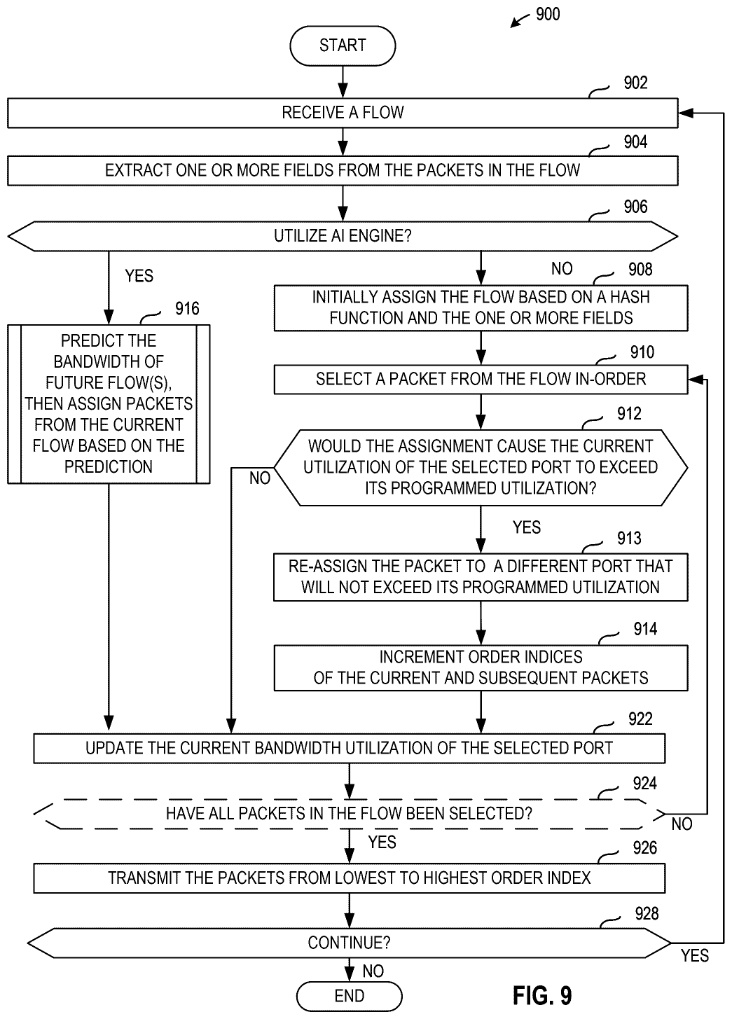

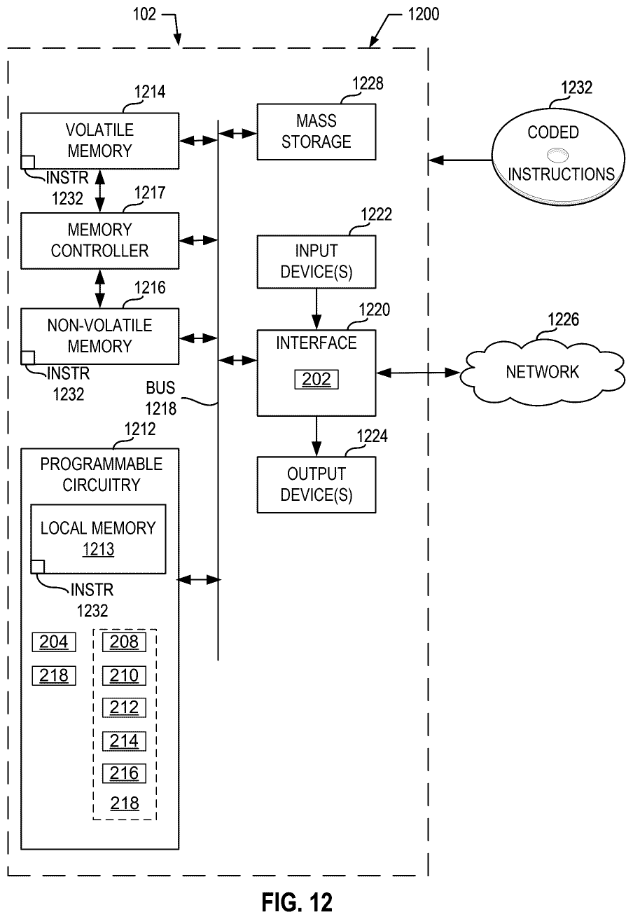

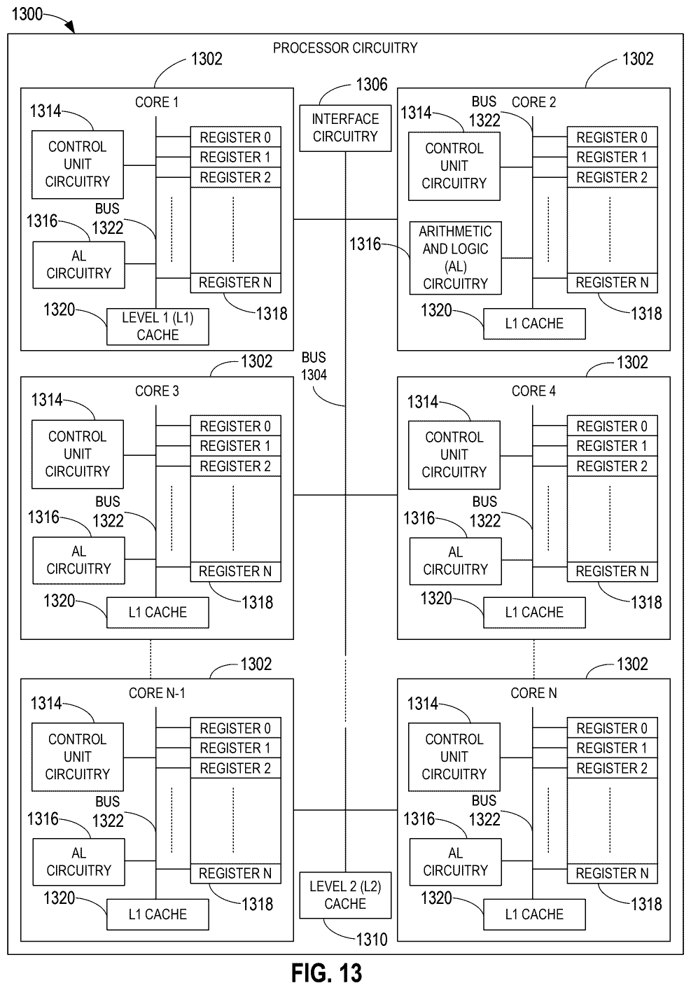

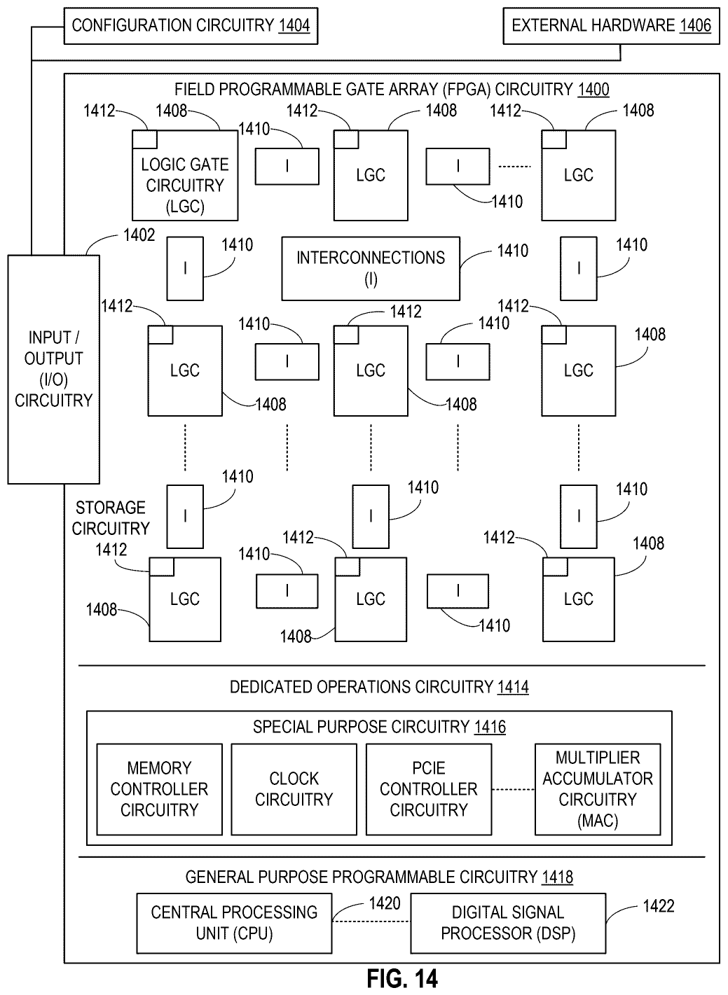

In some examples, the network switch circuitry 102 includes means for receiving data. For example, the means for receiving may be implemented by RX ports 202A. In some examples, the RX ports 202A may be instantiated by programmable circuitry such as the example programmable circuitry 1212 of FIG. 12. For instance, the RX ports 202A may be instantiated by the example microprocessor 1300 of FIG. 13 executing machine executable instructions such as those implemented by at least blocks 902 of FIG. 9. In some examples, the RX ports 202A may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the RX ports 202A may be instantiated by any other combination of hardware, software, and/or firmware. For example, the RX ports 202A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the network switch circuitry 102 includes means for transmitting data. For example, the means for transmitting may be implemented by TX ports 202B. In some examples, the TX ports 202B may be instantiated by programmable circuitry such as the example programmable circuitry 1212 of FIG. 12. For instance, the TX ports 202B may be instantiated by the example microprocessor 1300 of FIG. 13 executing machine executable instructions such as those implemented by at least blocks 926 of FIG. 9. In some examples, the TX ports 202B may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the TX ports 202B may be instantiated by any other combination of hardware, software, and/or firmware. For example, the TX ports 202B may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The packet processor circuitry 204 extracts one or more parameters from a given packet that it receives from the RX ports 202A. Such parameters may include but are not limited to source Internet Protocol (IP), destination IP, source Media Access Control (MAC), destination MAC, Layer 4 OSI data such as Transmission control Protocol (TCP) or User Datagram Protocol (UDP) ports, etc. In some examples, the packet processor circuitry 204 is instantiated by programmable circuitry executing packet processor instructions and/or configured to perform operations such as those represented by the flowchart(s) of FIGS. 9-11.

In some examples, the network switch circuitry 102 includes means for extracting packet parameters. For example, the means for extracting may be implemented by packet processor circuitry 204. In some examples, the packet processor circuitry 204 may be instantiated by programmable circuitry such as the example programmable circuitry 1212 of FIG. 12. For instance, the packet processor circuitry 204 may be instantiated by the example microprocessor 1300 of FIG. 13 executing machine executable instructions such as those implemented by at least blocks 904 of FIG. 9. In some examples, the packet processor circuitry 204 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the packet processor circuitry 204 may be instantiated by any other combination of hardware, software, and/or firmware. For example, the packet processor circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the assignment circuitry 208 within the LAG circuitry 206 assigns a given packet to one of the TX ports 202B based on the parameters extracted by the packet processor circuitry 204. In some examples, the assignments of all in-flight packets to their respective TX ports 202B are collectively referred to as a LAG configuration. In such examples, the assignment circuitry 208 performs an initial assignment by executing a hash function based on the parameters. The assignment circuitry 208 also provides the packet with an order_index value based on the initial assignment. As used herein, order_index refers to a positive integer whose value indicates the relative order in which packets are transmitted through the TX ports 202B. In some examples, the assignment circuitry 208 is instantiated by programmable circuitry executing assignment instructions and/or configured to perform operations such as those represented by the flowchart(s) of FIGS. 9-11.

In some examples, the network switch circuitry 102 includes means for performing an initial packet assignment. For example, the means for initial assignment may be implemented by assignment circuitry 208. In some examples, the assignment circuitry 208 may be instantiated by programmable circuitry such as the example programmable circuitry 1212 of FIG. 12. For instance, the assignment circuitry 208 may be instantiated by the example microprocessor 1300 of FIG. 13 executing machine executable instructions such as those implemented by at least blocks 908 of FIG. 9. In some examples, the assignment circuitry 208 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the assignment circuitry 208 may be instantiated by any other combination of hardware, software, and/or firmware. For example, the assignment circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the LB circuitry 210 determines whether the current bandwidth utilization of TX port 202B (e.g., P16 in FIG. 1) identified in the initial assignment would exceed its programmed bandwidth utilization with the addition of the packet. If the packet would cause the identified TX port 202B to exceeds its programmed bandwidth, the LB circuitry 210 reassigns the packet to a different TX port 202B (e.g., P17 in FIG. 1) that can support the packet assignment without exceeding its programmed bandwidth. In some examples, a packet reassignment is referred to as changing the LAG configuration. When a reassignment occurs, the LB circuitry 210 increments the order_index of the packet if the packet is reassigned but does not adjust the value of the order_index if the initial assignment of the packet is preserved. In some examples, the LB circuitry 210 is instantiated by programmable circuitry executing LB instructions and/or configured to perform operations such as those represented by the flowchart(s) of FIGS. 9-11.

In some examples, the network switch circuitry 102 includes means for load balancing. For example, the means for load balancing may be implemented by LB circuitry 210. In some examples, the LB circuitry 210 may be instantiated by programmable circuitry such as the example programmable circuitry 1212 of FIG. 12. For instance, the LB circuitry 210 may be instantiated by the example microprocessor 1300 of FIG. 13 executing machine executable instructions such as those implemented by at least blocks 910-914, 918, 920 of FIG. 9. In some examples, the LB circuitry 210 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the LB circuitry 210 may be instantiated by any other combination of hardware, software, and/or firmware. For example, the LB circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate. In some examples, the means for load balancing is referred to as means for forming a link aggregation group (LAG).

The utilization monitor circuitry 212 measures the amount of data flowing through the TX ports 202B per unit of time. The utilization monitor circuitry 212 uses the measurements to update the current bandwidth utilization for one or more of the TX ports 202B. For example, the utilization monitor circuitry 212 increases the current bandwidth utilization of the TX port that was ultimately assigned the packet because more data now needs to travel through said TX port. The utilization monitor circuitry 212 provides the current bandwidth utilization values to the LB circuitry 210 as feedback. The utilization monitor circuitry 212 also forwards the packet and its order_index to the ordering circuitry 214. In some examples, the utilization monitor circuitry 212 is instantiated by programmable circuitry executing utilization monitor instructions and/or configured to perform operations such as those represented by the flowchart(s) of FIGS. 9-11.

In some examples, the network switch circuitry 102 includes means for determining bandwidth utilization. For example, the means for determining may be implemented by utilization monitor circuitry 212. In some examples, the utilization monitor circuitry 212 may be instantiated by programmable circuitry such as the example programmable circuitry 1212 of FIG. 12. For instance, the utilization monitor circuitry 212 may be instantiated by the example microprocessor 1300 of FIG. 13 executing machine executable instructions such as those implemented by at least blocks 922 of FIG. 9. In some examples, the utilization monitor circuitry 212 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the utilization monitor circuitry 212 may be instantiated by any other combination of hardware, software, and/or firmware. For example, the utilization monitor circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the example of FIG. 2, the network switch circuitry 102 can perform LAG operations on two or more packets in parallel. Thus, at any point in time, there may be multiple packets awaiting transmission with an assigned TX port and corresponding order_index. In some examples, such packets are referred to as in-flight. The ordering circuitry 214 compares the order_index of all packets that are currently in-flight and forwards the packet with the lowest order_index value to the scheduler circuitry 218. In some examples, the ordering circuitry 214 is instantiated by programmable circuitry executing ordering instructions and/or configured to perform operations such as those represented by the flowchart(s) of FIGS. 9-11.

In some examples, the network switch circuitry 102 includes means for ordering packets. For example, the means for ordering may be implemented by ordering circuitry 214. In some examples, the ordering circuitry 214 may be instantiated by programmable circuitry such as the example programmable circuitry 1212 of FIG. 12. For instance, the ordering circuitry 214 may be instantiated by the example microprocessor 1300 of FIG. 13 executing machine executable instructions such as those implemented by at least blocks 924 of FIG. 9. In some examples, the ordering circuitry 214 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the ordering circuitry 214 may be instantiated by any other combination of hardware, software, and/or firmware. For example, the ordering circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The AI engine circuitry 216 is an optional component that may be present in devices implemented according to the teachings of this disclosure but is not required to be. When implemented (e.g., in FIG. 2), the AI engine circuitry 216 can predict, in near real time (near-RT), the bandwidth of future flows (e.g., 106-1) based on one or more of the extracted packet parameters from the packet processor circuitry 204, current bandwidth utilization values from the utilization monitor circuitry 212, and characteristics of the network 100, characteristics of the network switch circuitry 102. The bandwidth of a flow 106-1 is generally not available in or near real time because an RX port 202A receives a flow 106-1 as a sequential order of packets (as opposed to data that can be received in parallel because their order does not matter).

As used herein “near real time” (near-RT) refers to occurrence in a near instantaneous manner recognizing there may be real world delays for computing time, transmission, etc. Thus, unless otherwise specified, “near-RT” refers to real time plus an amount of time between 10 ms and 1 second. As used herein, “non real time” (non-RT) refers to real time plus an amount of time greater than 1 second.

In examples where the AI engine circuitry 216 is implemented, the assignment circuitry 208 forwards the packet to the LB circuitry 210 without performing an assignment. The LB circuitry 210 then assigns, based on the output of the AI engine circuitry 216, all packets from the current flow to a single TX port 202B that is predicted to be able to support said flow without exceeding its programmed utilization. That is, the AI engine circuitry 216 predicts how the future flows will affect the current utilization of the TX ports 202B in the future and the LB circuitry 210 assigns all packets from a flow to a single port based on the prediction. In some examples, the AI engine circuitry 216 may re-assign other packets if no such TX port 202B exist (e.g., because the current utilization values of all TX ports 202B are too large to support an entire flow of packets), thereby creating a port that is temporarily dedicated to one flow. In such an example, the LB circuitry 210 only need to update the order_index if the creation of a dedicated port causes the redistribution of other packets. By predicting the size of future flows and keeping the corresponding packets together on the same port, the AI engine circuitry 216 and LB circuitry 210 can reduce the number of order_index edits while still ensuring that none of the TX ports 202B exceed their programmed utilization.

The AI engine circuitry 216 may additionally or alternatively predict future flow bandwidth in a non-RT model. Rather than temporarily dedicating a port to a single flow predicted by the near-RT model, the LB circuitry 210 uses the output of non-RT model to distribute individual packets from the same flow across multiple TX ports 202B as described above. In some examples, the AI engine circuitry 216 reserves use of the near-RT model for high priority data and uses the non-RT model to perform best-effort (BE) operations on lower priority data.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, the AI engine circuitry 216 implements a near-RT and/or a non-RT model. Using a near-RT model enables the LB circuitry 210 to form link assignments based on the AI engine circuitry 216 while still meeting strict QoS timing requirements. Using a non-RT model enables the LB circuitry 210 to form link assignments based on the AI engine circuitry 216 while meeting best effort QoS timing requirements. In general, machine learning models/architectures that are suitable to use in the example approaches disclosed herein will be Artificial Neural Networks (ANNs) including Feedforward Neural Networks. However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

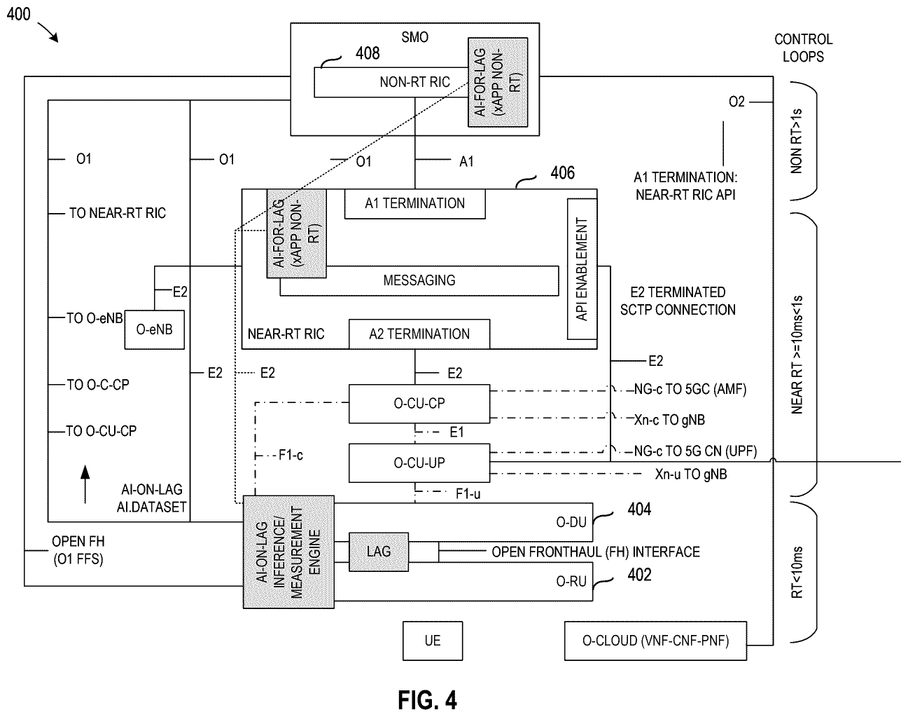

In examples disclosed herein, ML/AI models are trained using stochastic gradient descent. However, any other training algorithm may additionally or alternatively be used. In examples disclosed herein, training is performed until the average difference between the predicted bandwidth of a flow and the actual bandwidth of a flow is below a threshold. In some examples disclosed herein, training is performed on the network switch circuitry 102. In other examples, training is performed on one or more different devices within the network 100. Examples of such other training locations are described further in connection with FIGS. 3 and 4. Training is performed using hyperparameters that control how the learning is performed (e.g., a learning rate, a number of layers to be used in the machine learning model, etc.). In some examples re-training may be performed. Such re-training may be performed in response to the average difference between the predicted bandwidth of a flow and the actual bandwidth of a flow exceeding a threshold.

Training is performed using training data. In examples disclosed herein, the training data originates from the network switch circuitry 102, one or more other devices within the network 100, and the flows 106. Because supervised training is used, the training data is labeled. Labeling is applied to the training data by model training circuitry. In some examples, the training data is sub-divided into categories such as types of front haul links, historical telemetry data, and historical LAG configurations. These categories are described further in connection with FIGS. 10-12.

Once training is complete, the model(s) is deployed for use as an executable construct that processes an input and provides an output based on the network of nodes and connections defined in the model. The model(s) is stored in a memory resource of the network switch circuitry 102. The model(s) may then be executed by the AI engine circuitry 216.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

The training and operation of the deployed model cannot reasonably be performed in the human mind. For example, a human cannot reasonably predict flow bandwidths, in or near real-time and with sufficient accuracy to support network load balancing, in their mind. The AI engine circuitry 216 operates at least the collective data rate of the TX ports 202B (e.g., 300 Gbps in FIG. 1). Suppose the average amount of input data processed in a single execution of the AI model is 256 bytes. In such an example, the AI model processes the input data and generates an output (e.g., performs an assignment) approximately once every 853 picoseconds (as 256/300e9=853e-12). That is neither realistic nor practical for a human to achieve. Advantageously, the deployed models executed by the AI engine circuitry can decrease the likelihood of the TX ports 202B becoming overutilized by predicting the bandwidth of future flows and then assigning the current flow to one or more of the TX ports 202B at either a packet-level or a flow-level in view of the prediction.

In some examples, the AI engine circuitry 216 is instantiated by programmable circuitry executing AI engine instructions and/or configured to perform operations such as those represented by the flowchart(s) of FIGS. 9-11. In some examples, the network switch circuitry 102 includes means for predicting the bandwidth of a flow. For example, the means for predicting may be implemented by AI engine circuitry 216. In some examples, the AI engine circuitry 216 may be instantiated by programmable circuitry such as the example programmable circuitry 1212 of FIG. 12. For instance, the AI engine circuitry 216 may be instantiated by the example microprocessor 1300 of FIG. 13 executing machine executable instructions such as those implemented by at least blocks 916, 1002, 1004, 1102-1108 of FIGS. 9-11. In some examples, the AI engine circuitry 216 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the AI engine circuitry 216 may be instantiated by any other combination of hardware, software, and/or firmware. For example, the AI engine circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Outside the LAG circuitry 206, the scheduler circuitry 218 receives packets from the ordering circuitry 214. The scheduler circuitry 218 then transmits the packets in an order based on their adjusted order index values. To do so, the scheduler circuitry 218 holds a packet with a non-zero order_index until all packets that have a smaller order_index value are transmitted. The scheduler circuitry 218 then transmits the packet through the corresponding TX port 202B. Two or more packets may share the same order_index value because the LB circuitry 210 selectively increments the order_index when a reassignment occurs. In such examples, the scheduler circuitry 218 simultaneously transmits the two or more packets with the same order_index value through the corresponding two or more TX ports 202B. In some examples, the scheduler circuitry 218 is instantiated by programmable circuitry executing scheduler instructions and/or configured to perform operations such as those represented by the flowchart(s) of FIGS. 9-11.

In some examples, the network switch circuitry 102 includes means for scheduling transmissions. For example, the means for scheduling may be implemented by scheduler circuitry 218. In some examples, the scheduler circuitry 218 may be instantiated by programmable circuitry such as the example programmable circuitry 1212 of FIG. 12. For instance, the scheduler circuitry 218 may be instantiated by the example microprocessor 1300 of FIG. 13 executing machine executable instructions such as those implemented by at least blocks 926 of FIG. 9. In some examples, the scheduler circuitry 218 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the scheduler circuitry 218 may be instantiated by any other combination of hardware, software, and/or firmware. For example, the scheduler circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 3 is a block diagram of a first example environment that implements the network switch circuitry of FIGS. 1 and 2. FIG. 3 shows an example network 300 that includes an example User Equipment (UE) 302, an example Next Generation Radio Access Network (NG RAN) 304, example near-RT RAN intelligent controller (RIC) circuitry 306, an example model database 308, an example Next Generation Core Network (NG CN) 310, example model training circuitry 312, an example model database 314, and a Distinguished Name (DN) 315. The NG RAN 304 includes an example Radio Unit (RU) 316, an example Distributed Unit (DU) 318, an example Central Unit-Control Plane (CU-CP) 320, and an example Central Unit-User Plane (CU-UP) 322. The NG CN 310 includes an example Access and Mobility management Function (AMF) 324 and an example User Plane Function (UPF) 326.

The network 300 is an example implementation of the network 100 that implements an architecture defined by a Fifth Generation Third Generation Partnership Project (5G 3GPP) standard. Accordingly, components in the network 300 function as described in one or more 3GPP standard unless otherwise specified. In the example of FIG. 3, the network switch circuitry 102 is implemented by the DU 318 because it provides gNodeB (gNB) functionality as described in the 5G 3GPPP standard. Furthermore, the communication circuits 104 of FIG. 1 are implemented in the example of FIG. 3 by one or more of the near-RT RIC circuitry 306, the RU 316, the CU-CP 320, or the CU-UP 322. Additionally, the flows 106 of FIG. 1 are implemented in the example of FIG. 3 as front haul communications between the RU 316 and the DU 318. The front haul communications may be wired and/or wireless as described further below. In other examples, the flows 106 are not front haul communications.

The UE 302 is a device that relies on the RU 316 to connect to the NG CN 310. Once connected, the UE 302 may perform any type of data communication with the NG CN 310. Examples of such communication include but is not limited to fourth generation (4G) or fifth generation (5G) Internet browsing, Short Message Service (SMS) or Multimedia Messaging Service (MMS) texting, second generation (2G) or third generation (3G) phone calls, etc. In some examples, the UE device is referred to as a client device. UE devices include but are not limited to cell phones, tablets, laptops, smart watches, security cameras, Virtual Reality (VR)/Augmented Reality (AR) headsets, etc. More generally, UE devices may include any type of programmable circuitry.

The model database 308 includes one or more versions of the near-RT model used by the AI engine circuitry 216. The model database 308 also includes data used to train the one or more near-RT model versions. In the example of FIG. 3, the near-RT RIC circuitry 306 trains the near-RT models and the model database 308 is implemented externally from the network switch circuitry 102 (the DU 318).

The model database 314 includes one or more versions of the non-RT model used by the AI engine circuitry 216. The model database 314 also includes data used to train the one or more non-RT model versions. In the example of FIG. 3, the non-RT models and trained, and the model database 314 is implemented, externally from the network switch circuitry 102 (the DU 318).

FIG. 4 is a block diagram of a second example environment that implements the network switch circuitry of FIGS. 1 and 2. The network 400 of FIG. 4 is an example implementation of the network 100 that implements the Open Radio Access Network (O-RAN) architecture. The network 400 and the network 300 are similar to one another because the O-RAN architecture builds upon the 3GPP architecture. Accordingly, the acronyms of FIG. 3 also apply to FIG. 4, and components in the network 400 function as described in one or more 3GPPP and O-RAN standard unless otherwise specified. Moreover the example of FIG. 4, the network switch circuitry 102 of FIGS. 1 and 2 can be implemented in either the Open-RU 402 or the Open-DU 404, so long as the flows 106 correspond to the front haul communications between the Open-RU 402 and the Open-DU 404. Similarly, near-RT models used by the AI engine circuitry 216 are trained by the near-RT RIC circuitry 406 and is non-RT models used by the AI engine circuitry 216 are trained by the non-RT RIC circuitry 408 in the example of FIG. 4.

FIGS. 3 and 4 both show example networks that include one UE device that is serviced by one RU and one DU. More generally, the networks 100, 300, and 400 may include any number of UE devices supported by any number of RUs and any number of DUs. Accordingly, the functionality of the network switch circuitry 102 of FIGS. 1 and 2 to perform LB and LAG operations in accordance with the teachings of this disclosure may be implemented by any number of devices within a given network.

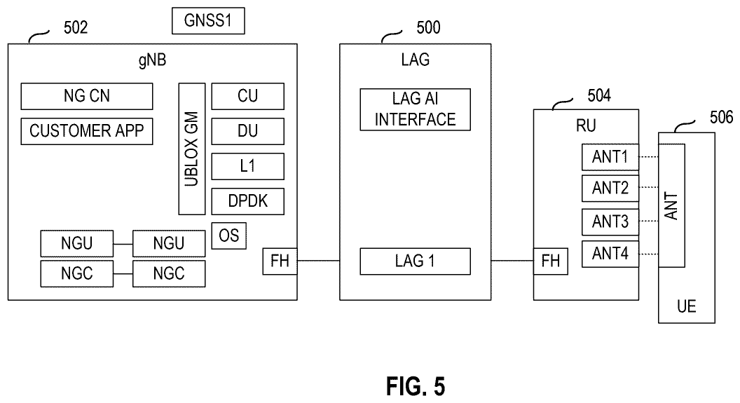

FIG. 5 is a block diagram of a third example environment that implements the network switch circuitry of FIGS. 1 and 2. The example of FIG. 5 is implemented in compliance with one or both of the 3GPP and ORAN standards, so the acronyms of FIGS. 3 and 4 apply to FIG. 5 as well. Furthermore, components in FIG. 5 function as described in one or more 3GPPP and O-RAN standard unless otherwise specified. In the example of FIG. 5, the gNB functionality is implemented by processor circuitry 502. The processor circuitry 502 also implements the CU, CN, and DU functionality as described in the 3GPP and ORAN standards, a customer software application, an operating system (OS), a Level 1 (L1) cache, and a Data Plane Development Kit (DPDK). The network switch circuitry 102 of FIGS. 1 and 2 (whose functionality is shown in FIG. 5 as the LAG block 500) can be implemented by either the processor circuitry 502 or the RU 504 in FIG. 5.

In the example of FIG. 5, the RU 504 communicates with the UE 506 using one or more antennas (ANT). Accordingly, the ports 202 support wireless communications in the example of FIG. 5. The wireless communications may be formatted in any number of communication protocols including but not limited to those described in the 3GPPP and ORAN standards. In some examples, the ports 202 additionally or alternatively support wired communications. Such wired communications may include but are not limited to Ethernet and Fiber Optics.

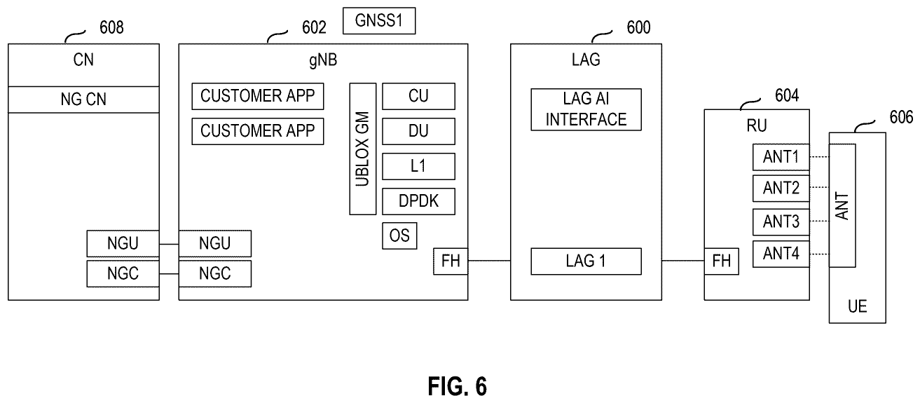

FIG. 6 is a block diagram of a third example environment that implements the network switch circuitry of FIGS. 1 and 2. The example of FIG. 6 is compliant with one or both of the 3GPP and ORAN standards, so the acronyms of FIGS. 3-5 apply to FIG. 6 as well. Furthermore, components in FIG. 6 function as described in one or more 3GPPP and O-RAN standard unless otherwise specified. In the example of FIG. 6, the Core Network (CN) is implemented on first processor circuitry 608 from the gNB functionality is implemented on second processor circuitry 608. The second processor circuitry 608 also implements multiple customer software applications in FIG. 6. Like the example of FIG. 5, the RU 604 communicates with the UE 606 using one or more antennas (ANT) and therefore support wireless communications. And like FIG. 5, the network switch circuitry 102 of FIGS. 1 and 2 (whose functionality is shown in FIG. 6 as the LAG block 600) can be implemented by either the processor circuitry 602 or the RU 604 in the example of FIG. 6. In other examples, the network switch circuitry 102 of FIGS. 1 and 2 is implemented as Network Interface Controller (NIC) circuitry or as Ethernet switch circuitry.

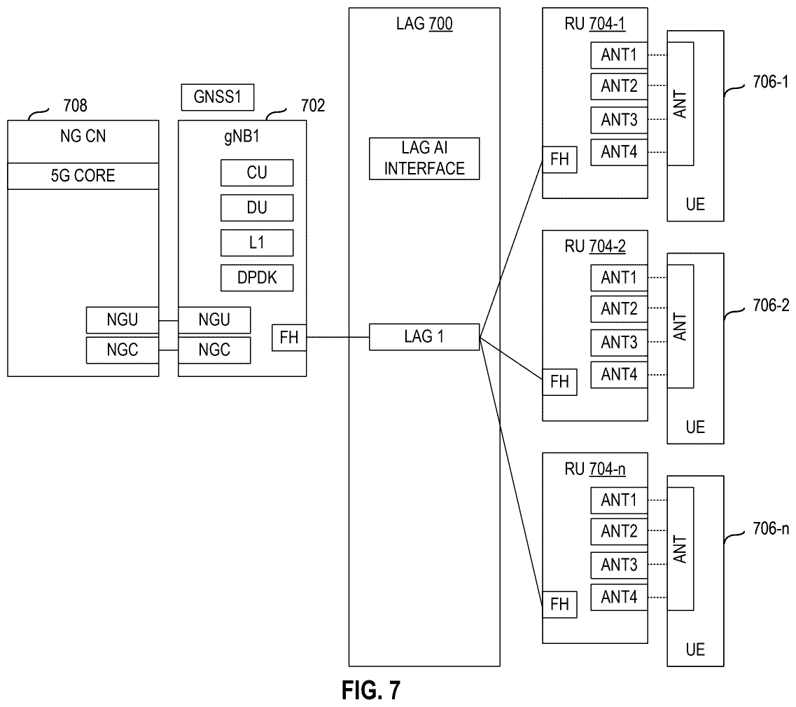

FIG. 7 is a block diagram of a third example environment that implements the network switch circuitry of FIGS. 1 and 2. The example of FIG. 7 is compliant with one or both of the 5G3PP and ORAN standards, so the acronyms of FIGS. 3-6 apply to FIGS. 7 as well. Furthermore, components in FIG. 7 function as described in one or more 3GPPP and O-RAN standard unless otherwise specified. In the example of FIG. 7, the network switch circuitry 102 of FIGS. 1 and 2 is implemented in the gNB device because the gNB device 702 aggregates traffic from multiple RUs 704. Thus, if the communication circuits 104-1 and 104-2 are implemented on separate devices, then FIG. 7 and FIG. 1 are similar because in both examples the network switch circuitry 102 (whose functionality is shown in FIG. 7 as the LAG block 700) receives flows 106 from multiple devices. Like FIG. 6 and unlike FIG. 5, the gNB device 70 and the NG CN 708 are implemented by separate processor circuits in the example of FIG. 7.

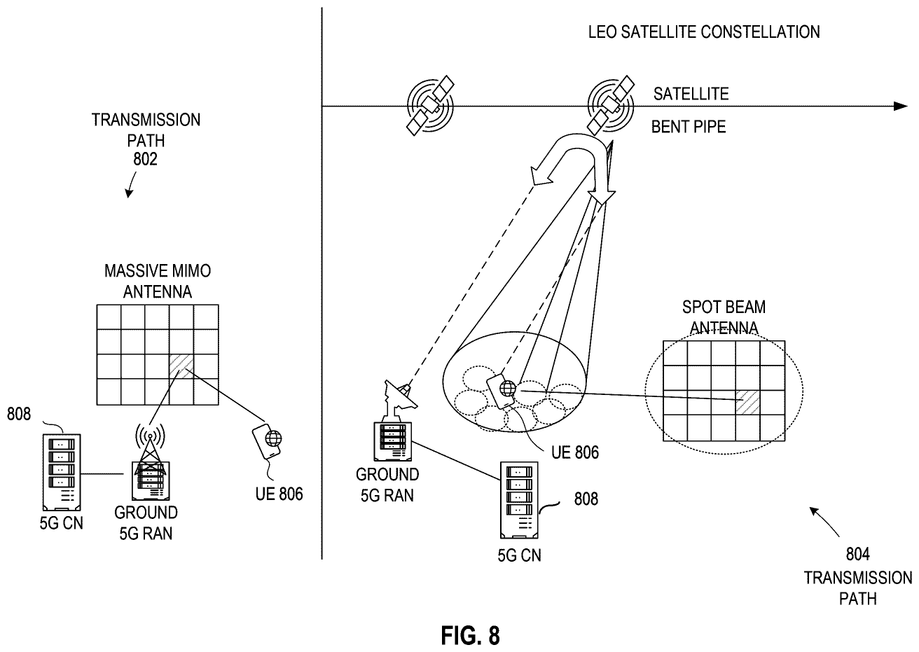

FIG. 8 is an illustrative example of two transmission paths 802 and 804 that include the network switch circuitry of FIG. 2. Both transmission paths 802 and 804 are compliant with the one or both of the 5G3PP and ORAN standards, so the acronyms of FIGS. 3-7 apply to FIG. 8 as well. Furthermore, both transmission paths include a 5G RAN that enables a UE device 806 to communicate with the 5G CN 808. In FIG. 7, the 5G RAN is an example implementation of the NG RAN 304 and the 5G CN is an example implementation of the NG CN 310 of FIG. 3. Thus, the network switch circuitry 102 of FIGS. 1 and 2 is implemented by one or more devices in the 5G RAN (e.g., RUs and/or gNB devices as described in FIGS. 3-7).

In the transmission path 802, the UE connects to the 5G RAN through a massive Multiple-Input Multiple-Output (MIMO). The massive MIMO utilizes a large number of antennas to increase the efficiency of the network. Accordingly, all devices in the transmission path 802 are on implemented on the ground.

The transmission path 804 is an example of regenerative Non Terrestrial Networking (NTN) architecture. In regenerative NTN, the UE, 5G RAN, and 5G CN are implemented on the ground but a packet generated by the UE travels through at least one intermediate device in space before reaching the 5G RAN. Similarly, a packet generated by the 5G CN travels through at least one intermediate device in space before reaching the device in regenerative NTN. Accordingly, in some examples, regenerative NTN is referred to as a bent-pipe architecture. In some examples, the intermediate device in space is implemented by a Low Earth Orbit (LEO) satellite. In the example of FIG. 8, a packet generated by the UE device in the transmission path 804 also travels through a spot beam antenna before reaching the satellite.

In some examples, the network switch circuitry 102 implements channel sounding techniques to test the quality of the wireless connections between it and the one or more communication circuits 104. Such testing may be particularly beneficial in bent-pipe architectures such as the transmission path 804 and/or in other types of adverse environments. In some examples, the channel sounding techniques include the exchange of one or more uplink sounding reference signals and/or downlink Reference Signal-Channel State Information (RS-CSI) signals.

NTN also supports a transparent architecture in which the gNB functionality of the 5G RAN is implemented on the intermediate device in space. Accordingly, in some transparent NTN examples, the network switch circuitry 102 of FIGS. 1 and 2 may be implemented by a satellite. The kinds of wireless communication supported by the ports 202 may therefore include radio waves, microwaves, non-terrestrial satellite feeder links, and/or any other suitable technology. More generally, the teachings of this disclosure may be implemented anywhere network architects desire to increase the performance of traffic between two connections.

While an example manner of implementing the network switch circuitry 102 of FIG. 1 is illustrated in FIG. 2, one or more of the elements, processes, and/or devices illustrated in FIG. 2 may be combined, divided, re- arranged, omitted, eliminated, and/or implemented in any other way. Further, the example packet processor circuitry 204, example assignment circuitry 208, example load balancer circuitry 210, example utilization monitor circuitry 212, example ordering circuitry 214, and example AI engine circuitry 216, example scheduler circuitry 218, and/or, more generally, the example network switch circuitry 102 of FIG. 2, may be implemented by hardware alone or by hardware in combination with software and/or firmware. Thus, for example, any of the example packet processor circuitry 204, example assignment circuitry 208, example load balancer circuitry 210, example utilization monitor circuitry 212, example ordering circuitry 214, and example AI engine circuitry 216, example scheduler circuitry 218, and/or, more generally, the example network switch circuitry 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example network switch circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the network switch circuitry 102 of FIG. 2 and/or representative of example operations which may be performed by programmable circuitry to implement and/or instantiate the network switch circuitry 102 of FIG. 2, are shown in FIGS. 9-11. The machine-readable instructions may be one or more executable programs or portion(s) of one or more executable programs for execution by programmable circuitry such as the programmable circuitry 1212 shown in the example programmable circuitry platform 1200 discussed below in connection with FIG. 12 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in

FIGS. 9-11, many other methods of implementing the example network switch circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-11 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement the network switch circuitry 102 of FIGS. 1 and 2. The example machine-readable instructions and/or the example operations 900 of FIG. 9 begin when one of the RX ports 202A receives a flow. (Block 902). The RX port 202A may receive the flow using any suitable wireless communication technology or any suitable wired communication technology as described above. The flow may be transmitted by any type of communication circuitry 104 (e.g., the UE 302, one or more components in the NG RAN 304, one or more components in the NG CN 310, etc.). The flow may include substantive data from one of the communication circuits 104 or include test data (e.g., to determine the quality of a connection in an adverse environment as described above). The packet may correspond to any amount of data.

The packet processor circuitry 204 extracts one or more fields from the packets in the flow. (Block 904). Such parameters may include but are not limited to source IP, destination IP, source MAC, destination MAC, Layer 4 OSI data such as TCP/UDP ports, etc. as described above.

The network switch circuitry 102 determines whether to utilize the AI engine circuitry 216. (Block 906). In some examples, the AI engine circuitry 216 is never utilized (Block 906: No) because the network switch circuitry 102 is not implemented with the AI engine circuitry 216. In other examples, the AI engine circuitry 216 is implemented within the network switch circuitry 102 but still may or may not be utilized for a given packet assignment. The network switch circuitry 102 may determine whether to utilize the AI engine circuitry 216 on a given packet assignment based on any number of factors including but not limited to the amount of computational resources on the device, the extent to which those computational resources are currently utilized by other tasks, instructions from different devices within the network 100, etc.

If the AI engine circuitry 216 is not utilized (Block 906: No), the assignment circuitry 208 initially assigns all packets in the flow to one of the TX ports 202B based on a hash function and the one or more extracted fields of block 904. (Block 908). To do so the assignment circuitry 208 may execute a hash function using the one or more extracted fields and then map a characteristic of the output of the hash function (e.g., the first character, the sum of the characters, etc.) to one of the TX ports 202B.

The LB circuitry 210 selects a packet from the flow in-order. (Block 910). For example, if the flow 106-1 is received at block 902, the LB circuitry 210 selects PK1 of flow 106-1 at the first instance of block 910, then selects PK2 of flow 106-1 at the next instance of block 910, etc.

The LB circuitry 210 determines whether the initial assignment of the packet from block 910 would cause the current bandwidth utilization of the selected port to exceeds its programmed bandwidth utilization. (Block 912). The programmed bandwidth utilization is a pre-determined threshold value that, if exceeded, may cause one or more devices within the network 100 to exhibit a failure mode as described above. The LB circuitry 210 implements block 910 by obtaining the current bandwidth utilization of the selected port from the utilization monitor circuitry 212. The LB circuitry 210 then calculates a hypothetical bandwidth utilization for the selected TX port 202B based on the current bandwidth utilization and the size of (e.g., the amount of data in) the packet.

If the selected TX port 202B will remain under its programmed bandwidth utilization with the addition of the initial assignment (Block 912: No), control proceeds to block 922. Alternatively, if the selected TX port 202B would exceed its programmed bandwidth utilization with the addition of the initial assignment (Block 912: Yes), the LB circuitry 210 reassigns the packet to a different TX port that will not exceed its programmed utilization. (Block 913). In some examples, the LB circuitry 210 reassigns the packet to whichever TX port currently has the lowest bandwidth utilization at block 912. A re-assignment of a first packet from a first port to a second port can be considered at least a temporary re-assignment of all subsequent packets that a) are received after the first packet and b were previously assigned to the first port. Accordingly, the subsequent packets will be transmitted across the second port unless the LB circuitry 210 performs an additional re-assignment.

The LB circuitry 210 increments the order_index of the current packet (e.g., the packet from the current instance of block 910) and the order_index value of all subsequent packets that were previously assigned to the same port. (Block 914). For example, in FIG. 1, the order_index value of PK3 of flow 106-1, and all of PK1, PK2, and PK3 of flow 106-2, are incremented from 0 to 1 at block 914 in response to the LB circuitry 210 transitioning from P16 to P17. At a later iteration of block 914, the LB circuitry 210 increments the order_index of PK1 of flow 106-2 again to 2. By incrementing the order_index of current and subsequent packets in response to a re-assignment to a different TX port 202B, the LB circuitry 210 ensures that the packet of block 902 is not transmitted before other packets that were received before it within the same flow.

If the network switch circuitry 102 does utilize the AI engine circuitry 216 (Block 906: Yes), the AI engine circuitry 216 predicts the bandwidth of future flow(s), then assigns packets from the current flow based on the prediction. (Block 916). In doing so, the AI engine circuitry 216 may update the order_index value of one or more packets. The AI engine circuitry 216 can execute either a near-RT model or a non-RT model to predict the bandwidth of future flows. More generally, the AI engine circuitry 216 predicts one or more characteristics of one or more future flows at block 916. The one or more characteristics may include but are not limited to a predicted bandwidth corresponding to one or more of the future flows. Block 916 is described further in connection with FIG. 10.

After either of blocks 912, 914, or 916, the utilization monitor circuitry 212 updates the current bandwidth utilization of the selected port. (Block 922). In some examples, the utilization monitor circuitry 212 also checks (and updates if necessary) the current bandwidth utilization of one or more other TX ports at block 922. The utilization monitor circuitry 212 provides the updated bandwidth value(s) to the LB circuitry 210, thereby enabling accurate assignment decisions for subsequent packets. The utilization monitor circuitry 212 provides the updated bandwidth value(s) to the AI engine circuitry 216 as feedback in examples where the AI engine circuitry 216 is utilized.

In examples where the AI engine circuitry 216 is not utilized, the LB circuitry 210 determines whether all packets in the flow have been selected. (Block 924). If some of the packets in the flow remain to be selected (Block 924: No), control returns to block 910 where the LB circuitry 210 selects the next packet in the flow. If all packets have been selected (Block 924: Yes), the scheduler circuitry 218 transmits the packets across one or more TX ports in order from the lowest order_index to the highest order_index. (Block 926). In examples where the AI engine circuitry 216 is utilized, control may proceed from block 922 directly to block 926 without implementing block 924.

The network switch circuitry 102 determines whether to continue performing operations in accordance with the teachings of this disclosure. (Block 928). The network switch circuitry 102 may not continue (Block 928: No) because the device is powered off or because the LAG circuitry 206 has been disabled. When the LAG circuitry 206 is disabled, the network switch circuitry 102 assigns packets to the TX ports 202B exclusively based on hash functions. The LAG circuitry 206 may be disabled for any reason including but not limited to a lack of computational resources, comparatively low QoS requirements that allow for comparatively longer delays between the network switch circuitry 102 receiving and subsequently transmitting a packet, etc.

If the network switch circuitry 102 does not continue (Block 928: No), the machine-readable instructions and/or operations 900 end after block 928. Alternatively, if the network switch circuitry 102 does continue performing operations in accordance with the teachings of this disclosure (Block 928: Yes), control returns to block 902 where one of the RX ports 202A receives another packet.

FIG. 10 is a flowchart representative of example machine-readable instructions and/or example operations that may be executed, instantiated, and/or performed by the network switch circuitry of FIG. 2 to predict the bandwidth of future flows, then assign packets from the current flow based on the prediction as described in FIG. 9. In particular, the flowchart of FIG. 10 is an example implementation of block 916 of FIG. 9.

Execution of block 916 begins when the AI engine circuitry 216 obtains model input data. (Block 1002). In some examples, the model input data includes the type of communication technology used by the RX port to obtain the packet at block 902. In such examples, the model input data indicates whether the packet was part of a wired or wireless front haul communication. The model input data also indicates which wireless front haul technology (e.g., microwave, radio wave, etc.) or wired front haul technology (e.g., Ethernet, fiber optics protocols, etc.) was used to receive the packet. Accordingly, the model input data can describe one or more types of front haul connections between external devices and the network switch circuitry 102.

In some examples, the model input data includes telemetry data. As used herein, telemetry data refers to data that describes at least the performance of the network switch circuitry 102. The telemetry data of block 1002 may include but is not limited to packets dropped, packets retransmitted, number of ports used, etc. In some examples, the telemetry data also describes the performance of one more other devices within the network 100. Such devices may include one or more components of the RAN and CN as described in FIGS. 3-8.

In some examples, the model input data includes QoS requirements. The QoS requirements describe one or more performance metrics that the network switch circuitry 102 is expected to meet in order to avoid a failure condition. For example, a QoS requirement may impose a maximum amount of time between when the network switch circuitry 102 receives and subsequently forwards a packet.

In some examples, the model input data includes extracted fields from packets. The extracted fields may describe whether the packet is part of a data stream that contains ordered packets (e.g. flows composed of multiple consecutive packets), unordered packets (e.g., flows composed of a single packet), or both. For example, data streams that support the Real-Time Steaming Protocol (RTSP) begin operations using ordered packets that comply with the Transport Control Protocol (TCP) and eventually transition to unordered packets that comply with the User Datagram Protocol (UDP). The extracted fields may also describe the application or environment where the packets are utilized. For example, the packets may be utilized in a RAN application, in an Over-The-Top (OTT) edge AI application, etc. In some examples, the model input data also includes the current bandwidth utilization values for the TX ports 202B as described above.

The AI engine circuitry 216 determines whether the flow is considered high priority. (Block 1004). The priority status of a flow can be application specific. For example, packets used in RAN applications are generally high priority, while packets used in OTT edge AI applications may be either high priority or low priority depending on the strictness of their QoS requirements. In some examples, the prioritization of a given flow is determined based on manual (e.g., human) input. In other examples, the prioritization of a given flow is determined by a separate AI model that operates independently of the AI engine circuitry 216.

If the flow is considered high-priority (Block 1004: Yes), the AI engine circuitry 216 executes a Near-RT machine learning model with the model input data. (Block 1006). The Near-RT machine learning model may have any architecture as described above. The output of the near-RT model is a prediction of the bandwidth for future flows (e.g., flows that will be received by the network switch circuitry 102 in the near future).

The LB circuitry 210 assigns all packets from the current flow to one output port based on the prediction of the near-RT model. (Block 1008). In some examples, assignments that occur at block 1008 based on the execution of the near-RT model of block 1008 is referred to as a change in LAG configuration.

In some examples, the LB circuitry 210 re-assign other packets at block 1008 to support the assignment of the flow from block 902. In such examples, the LB circuitry 210 updates the order-indices of current and subsequent packets when re-assignments occur. (Block 1010). The LB circuitry 210 implements the same logic at both block 1010 and 914 to increment order indices in response to a re-assignment.

If the flow is considered part of a low or intermediate priority (Block 1004: No), the AI engine circuitry 216 executes a non-RT machine learning model with the model input data. (Block 1012). The non-RT machine learning model may have any architecture as described above. The output of the non-RT model is also a prediction of the bandwidth for future flows (e.g., flows that will be received by the network switch circuitry 102 in the near future).

The LB circuitry 210 performs best effort LAG operations by distributing packets from the flow across one or more output ports based on the prediction. (Block 1014). Like block 1008, the LB circuitry 210 attempts to make assignments such that the none of the output ports 202B exceed their predicted future utilization. However, the LB circuitry 210 and near-RT model re-orders other packets besides the current high priority packets if necessary to perform the assignment of block 1008. In contrast, the LB circuitry 210 and non-RT model re-orders the current, low or intermediate priority packets if necessary to perform the assignment of block 1014.

In many examples, the LB circuitry 210 re-assigns packets from the current flow to support the assignments of block 1014. Accordingly, the LB circuitry 210 updates the order-indices of current and subsequent packets when re-assignments occur. (Block 1016). The LB circuitry 210 implements the same logic at both block 1016, 1010, and 914 to increment order indices in response to a re-assignment. Control returns to block 922 after either of block 1010 or 1016.

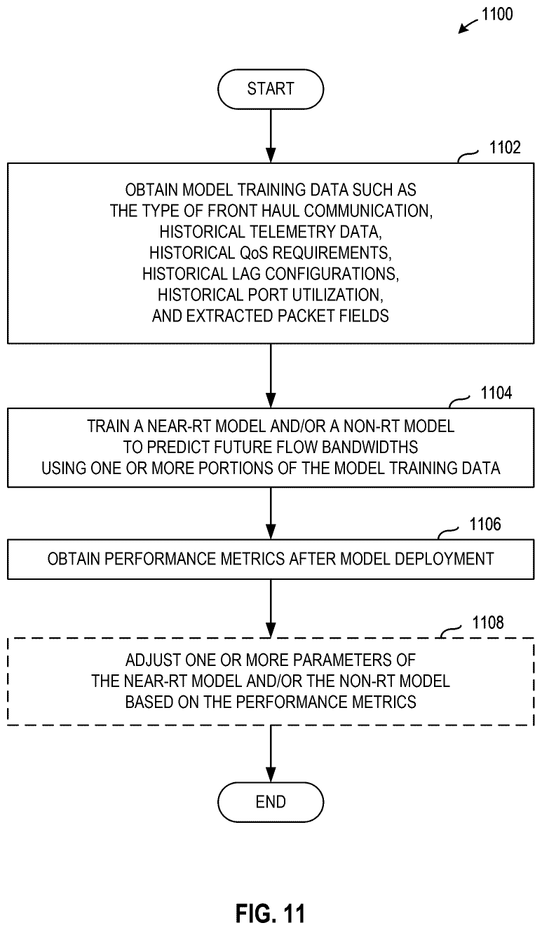

FIG. 11 is a flowchart representative of example machine-readable instructions and/or example operations 1100 that may be executed, instantiated, and/or performed by the network switch circuitry of FIG. 2 to train one or more artificial intelligence (AI) models to perform LB LAG. In the following description, model training circuitry implements the machine-readable instructions and/or example operations 1100. In some examples, one or more portions of the model training circuitry of FIG. 11 are implemented by the Near-RT RIC circuitry 306, the NG CN 310, and/or Non-RT RIC circuitry as shown in FIGS. 3 and 4. One or more portions of the model training circuitry may additionally or alternatively be implemented within the network switch circuitry 102.

The model training circuitry obtains model training data.

(Block 1102). The model training data may include types of front haul communication between various communication circuits 104 and network switch circuits 102, historical telemetry data, historical LAG configurations, historical QoS requirements, how the bandwidth utilization of ports on various network switch circuits 102 have changed in response to the historical LAG configuration changes, and extracted packet fields. In some examples, the model input data and/or model training data includes a priority status of the flow, an indication whether the flow is part of a data stream that includes only unordered packets, only ordered packets, or a mix of both unordered and ordered packets, and a network topology latency associated with the flow.

The model training data of FIG. 11 is therefore similar to the model input data of FIG. 10 in subject matter. However, while the model training data of FIG. 11 aggregates data from various network switch circuits 102 across the network 100 over time, the model input data of FIG. 10 is generally limited to data obtained by one instance of AI engine circuitry 216 (e.g., the instance that performs the subsequent model execution).

The model training circuitry trains a near-RT model and/or a non-RT model to predict future flow bandwidths using one or more portions of the model training data. (Block 1104). Training may be performed using any suitable technique as described above. In some examples, the operations of block 1104 end (e.g., training is completed) when the average difference between a predicted flow bandwidth and a measured flow bandwidth are below a threshold. In some examples, the model training circuitry trains one or more versions of a near-RT model and/or a non-RT model that are specific to a particular instance of the network switch circuitry 102.

The model training circuitry obtains performance metrics after deploying the one or more models. (Block 1106). The performance metrics includes at least the updated bandwidth utilization values from the utilization monitor circuitry 212. The performance metrics may additionally include updated telemetry data, updated telemetry data, etc.

The model training circuitry optionally adjusts one or more parameters of the near-RT model and/or non-RT model based on the performance metrics. (Block 1108). To update the one or more parameters of block 1108, the model training circuitry may change one or more values that adjust how near-RT model and/or non-RT model performs operations. Such values may influence embedding dimensions, values, or formatting, neural network weights or activation functions, etc. In some examples, the operations of block 1108 are referred to as model retraining. The machine-readable instructions and/or example operations 1100 end after block 1108.

FIG. 12 is a block diagram of an example programmable circuitry platform 1200 structured to execute and/or instantiate the example machine-readable instructions and/or the example operations of FIGS. 9-11 to implement the network switch circuitry 102 of FIG. 2. The programmable circuitry platform 1200 can be, for example, a server, a personal computer, a workstation, a self-learning machine (e.g., a neural network), or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, VPUs, DSPs, and/or microcontrollers from any desired family or manufacturer. The programmable circuitry 1212 may be implemented by one or more semiconductor based (e.g., silicon based) devices. In this example, the programmable circuitry 1212 implements example packet processor circuitry 204, example assignment circuitry 208, example load balancer circuitry 210, example utilization monitor circuitry 212, example ordering circuitry 214, and example AI engine circuitry 216, example scheduler circuitry 218.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1220 includes the ports 202.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1232, which may be implemented by the machine-readable instructions of FIGS. 9-11, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 9-11 to effectively instantiate the circuitry of FIG. 2 as logic circuits to perform operations corresponding to those machine-readable instructions. In some such examples, the circuitry of FIG. 2 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions and/or operations represented by the flowcharts of FIGS. 9-11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine-readable instructions. However, once configured, the FPGA circuitry 1400 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine-readable instructions represented by the flowchart(s) of FIGS. 9-11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-11. As such, the FPGA circuitry 1400 may be configured and/or structured to effectively instantiate some or all of the operations/functions corresponding to the machine-readable instructions of the flowchart(s) of FIGS. 9-11 as dedicated logic circuits to perform the operations/functions corresponding to those software instructions in a dedicated manner analogous to an ASIC. Therefore, the FPGA circuitry 1400 may perform the operations/functions corresponding to the some or all of the machine-readable instructions of FIGS. 9-11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine-readable instructions of FIGS. 9-11 and/or other desired operations.

The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine-readable instructions represented by the flowchart(s) of FIGS. 9-11 to perform first operation(s)/function(s), the FPGA circuitry 1400 of FIG. 14 may be configured and/or structured to perform second operation(s)/function(s) corresponding to a second portion of the machine-readable instructions represented by the flowcharts of FIGS. 9-11, and/or an

ASIC may be configured and/or structured to perform third operation(s)/function(s) corresponding to a third portion of the machine-readable instructions represented by the flowcharts of FIGS. 9-11.

It should be understood that some or all of the circuitry of FIG. 2 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1300 of FIG. 13 may execute machine-readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 2 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

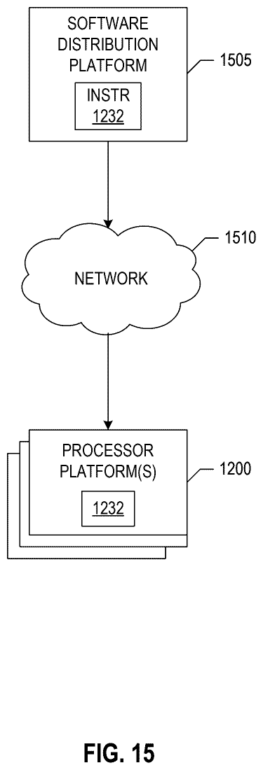

A block diagram illustrating an example software distribution platform 1505 to distribute software such as the example machine-readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine-readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine-readable instructions 1232, which may correspond to the example machine-readable instructions of FIGS. 9-11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1232 from the software distribution platform 1505. For example, the software, which may correspond to the example machine-readable instructions of FIG. 9-11, may be downloaded to the example programmable circuitry platform 1200, which is to execute the machine-readable instructions 1232 to implement the network switch circuitry 102. In some examples, one or more servers of the software distribution platform 1505 periodically offer, transmit, and/or force updates to the software (e.g., the example machine-readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”,

“second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” and “programmable circuit” are defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform LB LAG operations by preserving packet order and avoiding port overutilization. Disclosed systems, apparatus, articles of manufacture, and methods improve the efficiency of using a computing device by distributing packets that require in-order delivery across multiple different output ports, updating an order_index value when a reassignment occurs, and waiting to transmit a given packet until other packets with a lower order_index value have transmitted. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for load balanced link aggregation are disclosed herein. Further examples and combinations thereof include the following:

Example 1 includes an apparatus to perform network switching, the apparatus comprising interface circuitry, machine-readable instructions, and at least one programmable circuit to at least one of instantiate or execute the machine-readable instructions to assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG, and cause transmission of the plurality of packets across the first output port and the second output port in an order that maintains a relative position of the plurality of packets from the flow.

Example 2 includes the apparatus of example 1, wherein the at least one programmable circuit is to receive the plurality of packets from the flow in a sequence, and a failure condition occurs if the at least one programmable circuit cause transmission of the plurality of packets in an order that is different from the sequence.

Example 3 includes the apparatus of any one or more of examples 1-2, wherein a failure condition occurs if a bandwidth utilization of a given output port satisfies a threshold, and the at least one programmable circuit is to determine a number of packets in the first portion so the first output port does not satisfy the threshold during the transmission, and determine a number of packets in the second portion so the second output port does not satisfy the threshold during the transmission.

Example 4 includes the apparatus of any one or more of examples 1-3, wherein the assignment of the second portion of the plurality of packets to the second output port is a reassignment, the at least one programmable circuit is to perform an initial assignment of the second portion of the plurality of packets to the first output port, and perform the reassignment in response to a determination that a bandwidth utilization of the first output port would satisfy a threshold during transmission.

Example 5 includes the apparatus of example 4, wherein the apparatus further includes a third output port, and the at least one programmable circuit is to reassign the second portion of the plurality of packets to the second output port in response to a determination that a bandwidth utilization of the second output port is lower than a bandwidth utilization of the first output port.

Example 6 includes the apparatus of any one or more of examples 4-5, wherein the at least one programmable circuit is to perform the initial assignment based on a hash function.

Example 7 includes the apparatus of any one or more of examples 1-6, wherein the at least one programmable circuit is to assign order indices to the plurality of packets based on their relative position within the flow, adjust an order index of one or more of the packets during the assignments, and cause transmission of the packets across the first output port and the second output port based on the adjusted order index.

Example 8 includes the apparatus of example 7, wherein the at least one programmable circuit is to increment the order index of a packet in the second portion after a reassignment of the packet from the first output port to the second output port.

Example 9 includes the apparatus of any one or more of examples 7-8, wherein the at least one programmable circuit is to cause transmission of a packet from the first portion before a packet from the second portion in response to a determination that an order index of the packet from the first portion is lower than an order index of the packet from the second portion.

Example 10 includes the apparatus of any one or more of examples 1-9, wherein the at least one programmable circuit is to execute an Artificial Intelligence (AI) model to predict one or more characteristics of a flow to be received by the apparatus in the future, and after the execution of AI model, assign one or more of packets to the first output port and second output port based on the predicted bandwidth.

Example 11 includes the apparatus of example 10, wherein the at least one programmable circuit is to execute the AI model with model input data that includes one or more of a priority status of the flow, an indication whether the flow is part of a data stream that includes only unordered packets, only ordered packets, or a mix of both unordered and ordered packets, or a network topology latency associated with the flow.

Example 12 includes the apparatus of example 11, wherein the flow is a first flow, and wherein the at least one programmable circuit is to execute a non-real time (non-RT) AI model in response to determination a second flow is low or intermediate priority, and distribute packets from the second flow to multiple output ports.

Example 13 includes the apparatus of any one or more of examples 11-12, wherein the flow is a first flow, and wherein the at least one programmable circuit is to execute a near-real time (near-RT) AI model in response to a determination the second flow is high priority, and assign all packets from the second flow to a single output port.

Example 14 includes the apparatus of any one or more of examples 1-13, wherein the at least one programmable circuit is to receive a plurality of flows from a plurality of devices using one or more wireless front haul connections and wired front haul connections.

Example 15 includes the apparatus of example 14, wherein the one or more wireless front haul connections include one more radio waves, microwaves, and non-terrestrial satellite feeder links in compliance with Third Generation Partnership Project (3GPP) or Open Radio Access Network (ORAN) standards.

Example 16 includes the apparatus of any one or more of examples 14-15, wherein the one or more wired front haul connections include one or more Ethernet and Fiber Optics connections in compliance with Third Generation Partnership Project (3GPP) or Open Radio Access Network (ORAN) standards.

Example 17 includes a non-transitory machine-readable storage medium comprising instructions to cause at least one programmable circuit in a device to at least assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG, and cause transmission of the plurality of packets across the first output port and the second output port in an order that maintains a relative position of the plurality of packets from the flow.

Example 18 includes the non-transitory machine-readable storage medium of example 17, wherein the at least one programmable circuit is to receive the plurality of packets from the flow in a sequence, and a failure condition occurs if the at least one programmable circuit causes transmission of the plurality of packets in an order that is different from the sequence.

Example 19 includes the apparatus of any one or more of examples 17-18, wherein a failure condition occurs if a bandwidth utilization of a given output port satisfies a threshold, and the at least one programmable circuit is to determine a number of packets in the first portion so the first output port does not satisfy the threshold during the transmission, and determine a number of packets in the second portion so the second output port does not satisfy the threshold during the transmission.

Example 20 includes the apparatus of any one or more of examples 17-19, wherein the assignment of the second portion of the plurality of packets to the second output port is a reassignment, the at least one programmable circuit is to perform an initial assignment of the second portion of the plurality of packets to the first output port, and perform the reassignment in response to a determination that a bandwidth utilization of the first output port would satisfy a threshold during transmission.

Example 21 includes the non-transitory machine-readable storage medium of example 20, wherein the device further includes a third output port, and the at least one programmable circuit is to reassign the second portion of the plurality of packets to the second output port in response to a determination that a bandwidth utilization of the second output port is lower than a bandwidth utilization of the first output port.

Example 22 includes the apparatus of any one or more of examples 20-21, wherein the at least one programmable circuit is to perform the initial assignment based on a hash function.

Example 23 includes the apparatus of any one or more of examples 17-22, wherein the at least one programmable circuit is to assign order indices to the plurality of packets based on their relative position within the flow, adjust the order index of one or more of the packets during the assignments, and cause transmission of the packets across the first output port and the second output port based on the adjusted order index.

Example 24 includes the non-transitory machine-readable storage medium of example 23, wherein the at least one programmable circuit is to increment the order index of a packet in the second portion after a reassignment of the packet from the first output port to the second output port.

Example 25 includes the apparatus of any one or more of examples 23-24, wherein the at least one programmable circuit is to cause transmission of a packet from the first portion before a packet from the second portion in response to a determination that an order index of the packet from the first portion is lower than an order index of the packet from the second portion.

Example 26 includes the apparatus of any one or more of examples 17-25, wherein the at least one programmable circuit is to execute an Artificial Intelligence (AI) model to predict one or more characteristics of a flow to be received by the at least one programmable circuit in the future, and after the execution of AI model, assign one or more of packets to the first output port and second output port based on the predicted bandwidth.

Example 27 includes the non-transitory machine-readable storage medium of example 26, wherein the at least one programmable circuit is to execute the AI model with model input data that includes one or more of a priority status of the flow, an indication whether the flow is part of a data stream that includes only unordered packets, only ordered packets, or a mix of both unordered and ordered packets, or a network topology latency associated with the flow.

Example 28 includes the non-transitory machine-readable storage medium of example 27, wherein the flow is a first flow, and wherein the at least one programmable circuit is to execute a non-real time (non-RT) AI model in response to determination a second flow is low or intermediate priority, and distribute packets from the second flow to multiple output ports.

Example 29 includes the apparatus of any one or more of examples 27-28, wherein the flow is a first flow, and wherein the at least one programmable circuit is to execute a near-real time (near-RT) AI model in response to a determination the second flow is high priority, and assign all packets from the second flow to a single output port.

Example 30 includes the apparatus of any one or more of examples 17-29, wherein the at least one programmable circuit is to receive a plurality of flows from a plurality of devices using one or more wireless front haul connections and wired front haul connections.

Example 31 includes the non-transitory machine-readable storage medium of example 30, wherein the one or more wireless front haul connections include one more radio waves, microwaves, and non-terrestrial satellite feeder links in compliance with Third Generation Partnership Project (3GPP) or Open Radio Access Network (ORAN) standards.

Example 32 includes the apparatus of any one or more of examples 30-31, wherein the one or more wired front haul connections include one or more Ethernet and Fiber Optics protocols in compliance with Third Generation Partnership Project (3GPP) or Open Radio Access Network (ORAN) standards.

Example 33 includes an apparatus comprising means for load balancing to assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG, and means for transmitting the packets across the first output port and second output port in an order that maintains a relative position of the plurality of packets from the flow.

Example 34 includes the apparatus of example 33, further including means for receiving to receive the plurality of packets from the flow in a sequence, and a failure condition occurs if the means for transmitting transmits the plurality of packets in an order that is different from the sequence.

Example 35 includes the apparatus of any one or more of examples 33-34, wherein a failure condition occurs if a bandwidth utilization of a given output port satisfies a threshold, and the means for load balancing is to determine a number of packets in the first portion so the first output port does not satisfy the threshold during the transmission, and determine a number of packets in the second portion so the second output port does not satisfy the threshold during the transmission.

Example 36 includes the apparatus of any one or more of examples 33-35, wherein the assignment of the second portion of the plurality of packets to the second output port is a reassignment, the apparatus includes means for performing an initial assignment of the second portion of the plurality of packets to the first output port, and the means for load balancing is to perform the reassignment in response to a determination that a bandwidth utilization of the first output port would satisfy a threshold during transmission.

Example 37 includes the apparatus of example 36, wherein the apparatus further includes a third output port, and the means for load balancing is to reassign the second portion of the plurality of packets to the second output port in response to a determination that a bandwidth utilization of the second output port is lower than a bandwidth utilization of the first output port.

Example 38 includes the apparatus of any one or more of examples 36-37, wherein the means for performing an initial assignment is to perform the initial assignment based on a hash function.

Example 39 includes the apparatus of any one or more of examples 33-38, wherein the apparatus includes means for performing an initial assignment to assign order indices to the plurality of packets based on their relative position within the flow, the means for load balancing is to adjust the order index of one or more of the packets during the assignments, and the means for transmitting is transmit the packets across the first output port and the second output port based on the adjusted order index.

Example 40 includes the apparatus of example 39, wherein the means for load balancing is to increment the order index of a packet in the second portion after a reassignment of the packet from the first output port to the second output port.

Example 41 includes the apparatus of any one or more of examples 39-40, wherein the means for transmitting is to transmit a packet from the first portion before a packet from the second portion in response to a determination that an order index of the packet from the first portion is lower than an order index of the packet from the second portion.

Example 42 includes the apparatus of any one or more of examples 33-41, including means for predicting bandwidth of a flow to execute an Artificial Intelligence (AI) model to predict one or more characteristics a flow to be received by the apparatus in the future, and after the execution of AI model, assign one or more of packets to the first output port and second output port based on the predicted bandwidth.

Example 43 includes the apparatus of example 42, wherein the means for predicting the bandwidth of the flow is to execute the AI model with model input data that includes one or more of a priority status of the flow, an indication whether the flow is part of a data stream that includes only unordered packets, only ordered packets, or a mix of both unordered and ordered packets, or a network topology latency associated with the flow.

Example 44 includes the apparatus of example 43, wherein the flow is a first flow, and including means for predicting bandwidth of a flow to execute a non-real time (non-RT) AI model in response to determination a second flow is low or intermediate priority, and distribute packets from the second flow to multiple output ports.

Example 45 includes the apparatus of any one or more of examples 43-44, wherein the flow is a first flow, and including means for predicting bandwidth of a flow to execute a near-real time (near-RT) AI model in response to a determination the second flow is high priority, and assign all packets from the second flow to a single output port.

Example 46 includes the apparatus of any one or more of examples 33-45, further including means for receiving a flow to receive a plurality of flows from a plurality of devices using one or more wireless front haul connections and wired front haul connections.

Example 47 includes the apparatus of example 46, wherein the one or more wireless front haul connections include one more radio waves, microwaves, and non-terrestrial satellite feeder links in compliance with Third Generation Partnership Project (3GPP) or Open Radio Access Network (ORAN) standards.

Example 48 includes the apparatus of any one or more of examples 46-47, wherein the one or more wired front haul connections include one or more Ethernet and Fiber Optics protocols in compliance with Third Generation Partnership Project (3GPP) or Open Radio Access Network (ORAN) standards.

What is claimed is:

1. An apparatus to perform network switching, the apparatus comprising:
interface circuitry;
machine-readable instructions; and
at least one programmable circuit to at least one of instantiate or execute the machine-readable instructions to:
assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG; and
cause transmission of the plurality of packets across the first output port and the second output port in an order that maintains a relative position of the plurality of packets from the flow.

2. The apparatus of claim 1, wherein:
the at least one programmable circuit is to receive the plurality of packets from the flow in a sequence; and
a failure condition occurs if the at least one programmable circuit causes transmission of the plurality of packets in an order that is different from the sequence.

3. The apparatus of claim 1, wherein:
a failure condition occurs if a bandwidth utilization of a given output port satisfies a threshold; and
the at least one programmable circuit is to:
determine a number of packets in the first portion so the first output port does not satisfy the threshold during the transmission; and
determine a number of packets in the second portion so the second output port does not satisfy the threshold during the transmission.

4. The apparatus of claim 1, wherein:
the assignment of the second portion of the plurality of packets to the second output port is a reassignment;
the at least one programmable circuit is to:
perform an initial assignment of the second portion of the plurality of packets to the first output port; and
perform the reassignment in response to a determination that a bandwidth utilization of the first output port would satisfy a threshold during transmission.

5. The apparatus of claim 4, wherein:
the apparatus further includes a third output port; and
the at least one programmable circuit is to reassign the second portion of the plurality of packets to the second output port in response to a determination that a bandwidth utilization of the second output port is lower than a bandwidth utilization of the first output port.

6. The apparatus of claim 4, wherein the at least one programmable circuit is to perform the initial assignment based on a hash function.

7. The apparatus of claim 1, wherein the at least one programmable circuit is to:
assign order indices to the plurality of packets based on their relative position within the flow;
adjust an order index of one or more of the packets during the assignments; and
cause transmission of the packets across the first output port and the second output port based on the adjusted order index.

8. The apparatus of claim 7, wherein the at least one programmable circuit is to increment the order index of a packet in the second portion after a reassignment of the packet from the first output port to the second output port.

9. The apparatus of claim 7, wherein the at least one programmable circuit is to cause transmission of a packet from the first portion before a packet from the second portion in response to a determination that an order index of the packet from the first portion is lower than an order index of the packet from the second portion.

10. The apparatus of claim 1, wherein the at least one programmable circuit is to:
execute an Artificial Intelligence (AI) model to predict one or more characteristics of a flow to be received by the apparatus in the future; and
after the execution of AI model, assign one or more of packets to the first output port and second output port based on the predicted bandwidth.

11. The apparatus of claim 10, wherein the at least one programmable circuit is to execute the AI model with model input data that includes one or more of:
a priority status of the flow;
an indication whether the flow is part of a data stream that includes only unordered packets, only ordered packets, or a mix of both unordered and ordered packets; or a network topology latency associated with the flow.

12. The apparatus of claim 11, wherein the flow is a first flow, and wherein the at least one programmable circuit is to:
execute a non-real time (non-RT) AI model in response to determination a second flow is low or intermediate priority; and
distribute packets from the second flow to multiple output ports.

13. The apparatus of claim 11, wherein the flow is a first flow, and wherein the at least one programmable circuit is to:
execute a near-real time (near-RT) AI model in response to a determination the second flow is high priority; and
assign all packets from the second flow to a single output port.

14. The apparatus of claim 1, wherein the at least one programmable circuit is to receive a plurality of flows from a plurality of devices using one or more wireless front haul connections and wired front haul connections.

15. The apparatus of claim 14, wherein the one or more wireless front haul connections include one more radio waves, microwaves, and non-terrestrial satellite feeder links in compliance with Third Generation Partnership Project (3GPP) or Open Radio Access Network (ORAN) standards.

16. The apparatus of claim 14, wherein the one or more wired front haul connections include one or more Ethernet and Fiber Optics connections in compliance with Third Generation Partnership Project (3GPP) or Open Radio Access Network (ORAN) standards.

17. A non-transitory machine-readable storage medium comprising instructions to cause at least one programmable circuit in a device to at least:
assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG; and
cause transmission of the plurality of packets across the first output port and the second output port in an order that maintains a relative position of the plurality of packets from the flow.

18. The non-transitory machine-readable storage medium of claim 17, wherein:
the at least one programmable circuit is to receive the plurality of packets from the flow in a sequence; and
a failure condition occurs if the at least one programmable circuit causes transmission of the plurality of packets in an order that is different from the sequence.

19-32. (canceled)

33. An apparatus comprising:
means for load balancing to assign a first portion of a plurality of packets from a flow to a first output port of a link aggregation group (LAG) and a second portion of the plurality of packets of the flow to a second output port of the LAG, the assigning of the second portion of the plurality of packets to the second output port based on oversubscription of the first port of the LAG; and
means for transmitting the packets across the first output port and second output port in an order that maintains a relative position of the plurality of packets from the flow.

34. The apparatus of claim 33, further including:
means for receiving the plurality of packets from the flow in a sequence; and
a failure condition occurs if the means for transmitting transmits the plurality of packets in an order that is different from the sequence.

35-48. (canceled)
